(19) United States
(12) Patent Application Publication
(10) Pub. No.: US 2015/0253464 A1
(43) Pub. Date: Sep. 10, 2015

(54) PHOTOSENSITIVE RESIN COMPOSITION AND USES THEREOF

(71) Applicant: CHI MEI CORPORATION, TAINAN CITY (TW)

(72) Inventor: CHING-YUAN TSENG, TAINAN CITY (TW)

(21) Appl. No.: 14/716,671

(22) Filed: May 19, 2015

Related U.S. Application Data
(63) Continuation-in-part of application No. 14/523,160, filed on Oct. 24, 2014.

(30) Foreign Application Priority Data
Oct. 24, 2013 (TW) 102138368
May 28, 2014 (TW) 103118684

(51) Int. Cl. G02B 1/04; G02B 5/23

(52) U.S. Cl. CPC G02B 1/04; G02B 5/23

(57) ABSTRACT

The invention relates to a photosensitive resin composition for a black matrix, a color filter formed by the black matrix, and a liquid crystal display element. The photosensitive resin composition comprises an alkali-soluble resin (A), a compound (B) containing an ethylenically unsaturated group, a photoinitiator (C), a solvent (D), a black pigment (E), a compound (F) represented by Formula (a) and an epoxy resin (G) containing a fluorene skeleton represented by Formula (b). The photosensitive resin composition for the black matrix has the advantage of reducing film shrinkage and reducing roughness.

### BACKGROUND OF THE INVENTION

1. Field of the Invention

The invention relates to a photosensitive resin composition for a black matrix, a color filter formed by the black matrix, and a liquid crystal display element. More particularly, the invention provides a photosensitive resin composition which can reduce film shrinkage and reduce roughness for a black matrix, a color filter formed by the black matrix, and a liquid crystal display element.

2. Description of the Related Art

In recent years, a variety of liquid crystal display techniques have been developed, and in order to improve the contrast and display quality of the current liquid crystal display element, a black matrix is usually disposed in the gap of stripes and dots of the color filter in the display element. The black matrix can prevent issues such as decreases in contrast and color purity caused by light leakage between pixels. A material used in the conventional black matrix is mainly an evaporated film containing, for instance, chromium or chromium oxide. However, when the evaporated film is used as the material of the black matrix, disadvantages such as complicated process and costly materials exist. To solve these problems, a technique of forming the black matrix by a method of using a photosensitive resin composition through photolithography has previously been proposed.

Currently, the demand for shading property of the black matrix is increasing, and one solution is to increase the content of the black pigment, thereby improving the shading property of the black matrix. For instance, JP 2006-259716 discloses a photosensitive resin composition for a black matrix. The photosensitive resin composition includes a high content of a black pigment, an alkali-soluble resin, a photopolymerization initiator, a reactive monomer having two functional groups, and an organic solvent. In particular, the reactive monomer having two functional groups can improve the reaction between the compounds to form a pattern with high fineness. Therefore, in the photosensitive resin composition, when improving the shading property by a manner of increasing the content of the black pigment, the sensitivity of the photosensitive resin composition can still be maintained.

Further, JP 2008-268854 discloses a photosensitive resin composition for a black matrix. The photosensitive resin composition includes an alkali-soluble resin having a carboxylic acid group and an unsaturated group, a photopolymerized monomer having an ethylenically unsaturated group, a photopolymerization initiator, and a high content of black pigment. The photosensitive resin composition for the black matrix improves the resolution of the photosensitive resin composition having the high content of black pigment by using the specific alkali-soluble resin.

Although the current photosensitive resin composition having increased content of the black pigment can increase the shading property, the conventional photosensitive resin compositions mentioned above readily generates issues such as serious film shrinkage of the black matrix after post baking and the roughness cannot be accepted in the field. Therefore, a photosensitive resin composition which can reduce film shrinkage and reduce roughness for a black matrix is still required.

### SUMMARY OF THE INVENTION

In the present invention, a specific alkali-soluble resin and compound are provided to obtain a photosensitive resin composition which can reduce film shrinkage and reduce roughness for a black matrix.

Therefore, the present invention provides a photosensitive resin composition comprising:

an alkali-soluble resin (A);

a compound (B) containing an ethylenically unsaturated group;

a photoinitiator (C);

a solvent (D);

a black pigment (E);

a compound (F) represented by Formula (a); and

an epoxy resin (G) containing a fluorene skeleton represented by Formula (b);

wherein

the alkali-soluble resin (A) comprises a resin having an unsaturated group (A-1) obtained by polymerizing a mixture which comprises an epoxy compound (i) having at least two epoxy groups and a compound (ii) having at least one carboxylic acid group and at least one ethylenically unsaturated group;

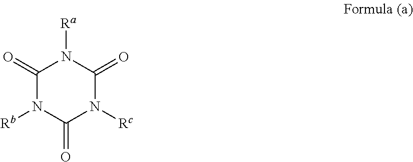

in Formula (a):

R^{a}, R^{b} and R^{c} each independently represent a trialkoxysilyl group linked to an alkylene group or an arylene group; and

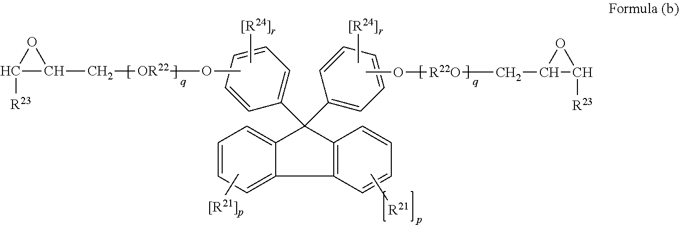

in Formula (b):

R²¹ represents a cyano group, a C₁-C₅ alkyl group or a halogen atom;

R²² represents a C₁-C₁₃ alkylene group;

R²³ represents a hydrogen atom or a methyl group;

R²⁴ represents a C₁-C₅ alkyl group, a C₆-C₁₂ aryl group or a C₆-C₁₂ aralkyl group;

p represents an integer from 0 to 4;

q represents an integer from 1 to 10; and

r represents an integer from 0 to 4.

The present invention also provides a black matrix, which is formed by photosensitive resin composition as mentioned above.

The present invention also provides a color filter comprising the black matrix as mentioned above.

The present invention further provides a liquid crystal display element comprising the color filter as mentioned above.

### DETAILED DESCRIPTION OF THE INVENTION

The present invention provides a photosensitive resin composition comprising: an alkali-soluble resin (A);

a compound (B) containing an ethylenically unsaturated group;

a photoinitiator (C);

a solvent (D);

a black pigment (E);

a compound (F) represented by Formula (a); and

an epoxy resin (G) containing a fluorene skeleton represented by Formula (b);

wherein

the alkali-soluble resin (A) comprises a resin having an unsaturated group (A-1) obtained by polymerizing a mixture which comprises an epoxy compound (i) having at least two epoxy groups and a compound (ii) having at least one carboxylic acid group and at least one ethylenically unsaturated group;

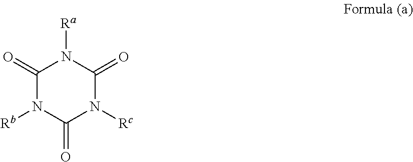

in Formula (a):

R^{a}, R^{b} and R^{c} each independently represent a trialkoxysilyl group linked to an alkylene group or an arylene group; and

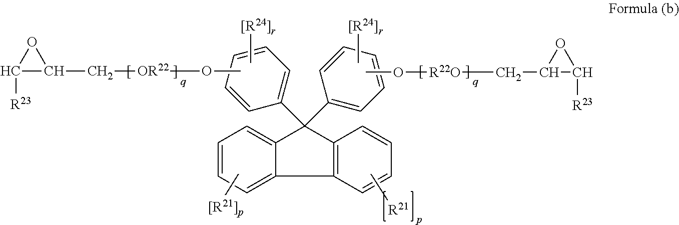

in Formula (b):

R²¹ represents a cyano group, a C₁-C₅ alkyl group or a halogen atom.

R²² represents a C₁-C₁₃ alkylene group;

R²³ represents a hydrogen atom or a methyl group;

R²⁴ represents a C₁-C₅ alkyl group, a C₆-C₁₂ aryl group or a C₆-C₁₂ aralkyl group;

p represents an integer from 0 to 4;

q represents an integer from 1 to 10; and

r represents an integer from 0 to 4.

The epoxy compound (i) having at least two epoxy groups according to the present invention can contain structure represented by Formula (I) or Formula (II) as below. Herein, “the structure represented by Formula (I) or Formula (II)” also includes the epoxy compound (i) having the structures represented by Formula (I) and Formula (II) at the same time. For example, the structure of the aforementioned epoxy compound (i) having at least two epoxy groups is represented by Formula (I):

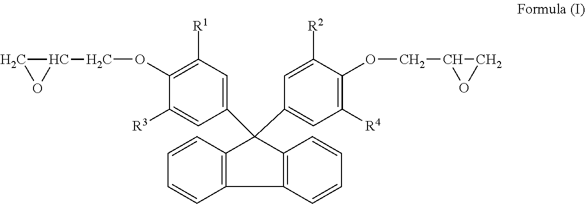

wherein;

R¹, R², R³ and R⁴ independently represent a hydrogen atom, a halogen atom, a C₁-C₅ alkyl group, a C₁-C₅ alkoxy group, a C₆-C₁₂ aryl group or a C₆-C₁₂ aralkyl group.

The aforementioned epoxy compound (i) having at least two epoxy groups represented by Formula (I) includes but is not limited to a bisphenol fluorene containing an epoxy group obtained by reacting a bisphenol fluorene and an epihalohydrin.

Examples of the aforementioned bisphenol fluorene are 9,9-bis(4-hydroxyphenyl)fluorene, 9,9-bis(4-hydroxy-3-methylphenyl)fluorene, 9,9-bis(4-hydroxy-3-chlorophenyl)fluorene, 9,9-bis(4-hydroxy-3-bromophenyl)fluorene, 9,9-bis(4-hydroxy-3-fluorophenyl)fluorene, 9,9-bis(4-hydroxy-3-methoxyphenyl)fluorene, 9,9-bis(4-hydroxy-3,5-dimethylphenyl)fluorene, 9,9-bis(4-hydroxy-3,5-dichlorophenyl)fluorene, 9,9-bis(4-hydroxy-3,5-dibromophenyl)fluorene or the like.

Examples of the aforementioned epihalohydrin include but are not limited to 3-chloro-1,2-epichlorohydrin, 3-bromo-1,2-epibromohydrin or the like.

The aforementioned bisphenol fluorene containing the epoxy group obtained by reacting the bisphenol fluorene and the epihalohydrin includes but is not limited to: (1) ESF-300 manufactured by Nippon Steel Chemical Co., Ltd; (2) EG-210 manufactured by Osaka Gas Co., Ltd; (3) SMS-F9PhPG, SMS-F9CrG, or SMS-F914PG manufactured by S.M.S Technology Co., Ltd.

In one another embodiment of the invention, the aforementioned epoxy compound (i) having at least two epoxy groups contains a structure represented by Formula (II):

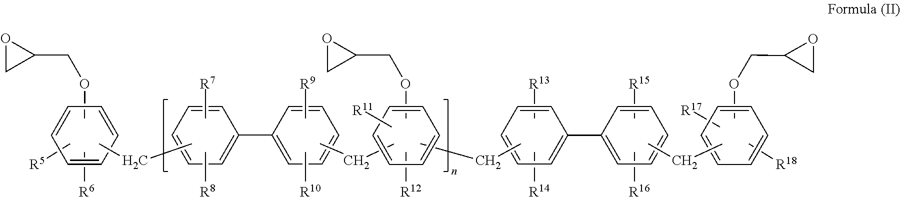

wherein:

R⁵ to R¹⁸ independently represent a hydrogen atom, a halogen atom, a C₁-C₈ alkyl group or a C₆-C₁₅ aromatic group; and n represents an integer from 0 to 10.

The aforementioned epoxy compound (i) having at least two epoxy groups represented by Formula (II) is obtained by reacting a compound represented by Formula (II-1) as below and an epihalohydrin in the presence of an alkali metal hydroxide:

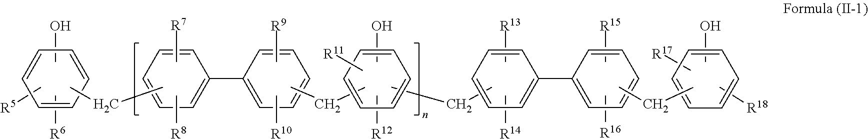

In Formula (II-1), R⁵ to R¹⁸ and n are the same to the definition with Formula (II), and are not repeated again.

Furthermore, the aforementioned epoxy compound (i) having at least two epoxy groups represented by Formula (II) is obtained by condensing a compound represented by Formula (II-2) and phenol in the presence of an acid catalyst, thereby forming the compound represented by Formula (II-1). Next, a dehydrohalogenation is carried out by adding excess of an epihalohydrin into the above reaction solution, so as to obtain the epoxy compound (i) having at least two epoxy groups represented by Formula (II):

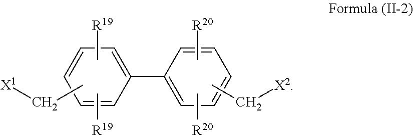

In Formula (II-2), R¹⁹ and R²⁰ are the same or different from each other, each of which independently represents a hydrogen atom, a halogen atom, a C₁-C₈ alkyl group or a C₆-C₁₅ aromatic group; X¹ and X² independently represent a halogen atom, a C₁-C₆ alkyl group or a C₁-C₆ alkoxy group. Preferably, the halogen atom may be chlorine or bromine; the alkyl group may be a methyl, ethyl or tert-butyl group; the alkoxy group may be a methoxy or ethoxy group.

Examples of the aforementioned phenol are phenol, cresol, ethylphenol, n-propylphenol, isobutylphenol, t-butylphenol, octylphenol, nonylphenol, xylenol, methylbutylphenol, di-t-butylphenol, vinylphenol, propenylphenol, ethinylphenol, cyclopentylphenol, cyclohexylphenol, cyclohexylcresol or the like. The aforementioned phenols can be used alone or in admixture of two or more thereof.

Based on 1 mole of the used amount of the aforementioned compound represented by Formula (II-2), the used amount of the phenol is 0.5 to 20 moles; preferably the used amount of the phenol is 2 to 15 moles.

Examples of the aforementioned acid catalyst are hydrogen chloride, sulfuric acid, p-toluenesulfonic acid, oxalic acid, boron trifluoride, aluminium chloride anhydrous, zinc chloride or the like; wherein p-toluenesulfonic acid, hydrogen chloride and sulfuric acid are preferably used. The aforementioned acid catalyst can be used alone or in admixture of two or more thereof.

In addition, there are no specific limitations to the used amount of the aforementioned acid catalyst. Preferably, based on 100 percentages by weight of the compound represented by Formula (II-2), the used amount of the acid catalyst is 0.1 to 30 percentages by weight.

The aforementioned condensation reaction can be performed without any solvent or in the presence of an organic solvent. Examples of the aforementioned organic solvent are toluene, xylene, methyl isobutyl ketone or the like. The aforementioned organic solvent can be used alone or in admixture of two or more thereof.

Based on 100 percentages by weight of the total used amount of the compound represented by Formula (II-2) and the phenol, the used amount of the organic solvent is 50 percentages by weight to 300 percentages by weight; preferably 100 percentages by weight to 250 percentages by weight. In addition, the aforementioned condensation reaction is operated under a temperature of 40° C. to 180° C. for a period of 1 hour to 8 hours.

After the condensation reaction is finished, a neutralization or rinse treatment can be performed. In the aforementioned neutralization treatment, pH value of the reaction solution is adjusted to pH 3 to pH 7, and preferably pH 5 to pH 7. A neutralization reagent may be used in the aforementioned rinse treatment, in which the neutralization reagent is an alkaline substance, for examples, alkali metal hydroxides such as sodium hydroxide, potassium hydroxide or the like; alkaline earth metal hydroxides such as calcium hydroxide, magnesium hydroxide or the like; organic amines such as diethylene triamine, triethylenetetramine, aniline, phenylene diamine or the like; and ammonia, sodium dihydrogen phosphate or the like. Conventional manners can be used in the aforementioned rinse treatment. For example, a neutralizing reagent-containing solution is added into the reaction solution followed by repetitively extracting. After the neutralization or rinse treatment is finished, unreactive phenols and solvents in the product are evaporated and removed by using a heating treatment under a decreased pressure, and then concentrated, thereby obtaining the compound represented by Formula (II-1).

Examples of the aforementioned epihalohydrin are 3-chloro-1,2-epichlorohydrin, 3-bromo-1,2-epibromohydrin or the combination thereof. Before preceding the aforementioned dehydrohalogenation, alkali metal hydroxides such as sodium hydroxide, potassium hydroxide can be added before or during the reaction process. The aforementioned dehydrohalogenation is carried out under a temperature of 20° C. to 120° C. for a period of 1 hour to 10 hours.

In an embodiment, the formulation of the alkali metal hydroxide can be also used in an aqueous solution for adding into the aforementioned dehydrohalogenation reaction system. In the embodiment, when the solution of the alkali metal hydroxides is continuously added into the dehydrohalogenation reaction system, water and the epihalohydrin can be simultaneously distillated out under a normal or decreased pressure, thereby separating and removing water, as well as reflowing the epihalohydrin back into the reaction system continuously.

Before the aforementioned dehydrohalogenation is carried out, a tertiary ammonium salt such as tetramethyl ammonium chloride, tetramethyl ammonium bromide, trimethyl benzyl ammonium chloride or the like can be used as a catalyst and added into the dehydrohalogenation reaction system, followed by performing the dehydrohalogenation under a temperature of 50° C. to 150° C. for a period of 1 hour to 5 hours. Next, the alkali metal hydroxide or its solution can be then added into such reaction system under a temperature of 20° C. to 120° C. for a period of 1 hour to 10 hours for carrying out the dehydrohalogenation.

Based on the total hydroxyl groups in the compound represented by Formula (II-1) as 1 equivalent, the used amount of the epihalohydrin is 1 to 20 equivalents; preferably 2 to 10 equivalents. Based on the total hydroxyl groups in the compound represented by Formula (II-1) as 1 equivalent, the used amount of the alkali metal hydroxide added in the dehydrohalogenation is 0.8 to 15 equivalents; preferably 0.9 to 11 equivalents.

In addition, for the purpose of success of the dehydrohalogenation, besides adding an alcohol such as methanol or ethanol, a polar aprotic solvent such as dimethyl sulfone, dimethyl sulfoxide or the like can be also added. When the alcohol is used in the reaction, based on 100 percentages by weight of the used amount of the epihalohydrin, the used amount of the alcohol is 2 to 20 percentages by weight; preferably 4 to 15 percentages by weight. When the polar aprotic solvent is used in the reaction, based on 100 percentages by weight of the used amount of the epihalohydrin, the used amount of the polar aprotic solvent is 5 to 100 percentages by weight; preferably 10 to 90 percentages by weight.

After the dehydrohalogenation is completed, a rinse treatment is optionally performed. Afterward, the epihalohydrin, the alcohol and the polar aprotic solvent can be removed by using a heating treatment of 110° C. to 250° C. under a decreased pressure of less than 1.3 kPa (10 mmHg).

For preventing the resulted epoxy resin from remaining hydrolytic halogen therein, toluene, methyl isobutyl ketone or the like can be added into the solution that has reacted after the dehydrohalogenation, and then the solution of the alkali metal hydroxide such as sodium hydroxide, potassium hydroxide can be added to perform the dehydrohalogenation again. During the dehydrohalogenation, based on the total hydroxyl groups in the compound represented in Formula (II-1) as 1 equivalent, the used amount of the alkali metal hydroxide added in the dehydrohalogenation is 0.01 to 0.3 moles; preferably 0.05 to 0.2 moles. In addition, the dehydrohalogenation is operated in a temperature of 50° C. to 120° C. for a period of 0.5 hour to 2 hours.

After the dehydrohalogenation is finished, salts can be removed by using processes of filtration, rinse and so on. In addition, toluene, methyl isobutyl ketone and the like can be distilled out and removed, thereby obtaining the epoxy compound (i) having at least two epoxy groups represented by Formula (II). The epoxy compound (i) having at least two epoxy groups represented by Formula (II) includes but is not limited to the commercially available products such as NC-3000, NC-3000H, NC-3000S, NC-3000P or so on manufactured by Nippon Kayaku Co., Ltd.

The aforementioned the compound (ii) having at least one carboxylic acid group and at least one ethylenically unsaturated group is selected from the group consisting of the following subgroups (1) to (3): (1)acrylic acid, methacrylic acid, 2-methacryloyloxyethyl butanedioic acid, 2-methacryloyloxybutyl butanedioic acid, 2-methacryloyloxyethyl hexanedioic acid, 2-methacryloyloxybutyl hexanedioic acid, 2-methacryloyloxyethyl hexahydrophthalic acid, 2-methacryloyloxyethyl maleic acid, 2-methacryloyloxypropyl maleic acid, 2-methacryloyloxybutyl maleic acid, 2-methacryloyloxypropyl butanedioic acid, 2-methacryloyloxypropyl hexanedioic acid, 2-methacryloyloxypropyl tetrahydrophthalic acid, 2-methacryloyloxypropyl phthalic acid, 2-methacryloyloxybutyl phthalic acid, or 2-methacryloyloxybutyl hydrophthalic acid; (2) a compound obtained by reacting (methyl)acrylate ester containing a hydroxyl group with a dicarboxylic acid compound, in which the dicarboxylic acid compound includes but is not limited to hexanedioic acid, butanedioic acid, maleic acid or phthalic acid; and (3) a hemiester compound obtained by reacting (methyl)acrylate ester containing a hydroxyl group with a carboxylic anhydride compound (iii), in which the (methyl)acrylate ester containing a hydroxyl group includes but is not limited to (2-hydroxyethyl) acrylate, (2-hydroxyethyl) methacrylate, (2-hydroxypropyl)acrylate, (2-hydroxypropyl) methacrylate, (4-hydroxybutyl)acrylate, (4-hydroxybutyl) methacrylate, pentaerythritol triacrylate or the like. In addition, the carboxylic anhydride compound described herein can be the same with the carboxylic anhydride compound (iii) in the mixture of the resin having the unsaturated group (A-1) as follows rather than being recited herein.

The mixture of the resin having the unsaturated group (A-1) can further optionally include the carboxylic anhydride compound (iii) and/or a compound (iv) having an epoxy group. The aforementioned carboxylic anhydride compound (iii) is selected from the group consisting of the following subgroups (1) to (2): (1) dicarboxylic anhydride compounds such as butanedioic anhydride, maleic anhydride, itaconic anhydride, phthalic anhydride, tetrahydrophthalic anhydride, hexahydrophthalic anhydride, methyl tetrahydrophthalic anhydride, methyl hexahydrophthalic anhydride, methyl endo-methylene tetrahydrophthalic anhydride, chlorendic anhydride, glutaric anhydrid, or 1,3-dioxoisobenzofuran-5-carboxylic anhydride; and (2) tetracarboxylic dianhydride compounds such as benzophenone tetracarboxylic dianhydride (referred to as BTDA), diphenyl tetracarboxylic dianhydride, diphenyl ether tetracarboxylic dianhydride or the like.

The aforementioned compound (iv) having the epoxy group is selected from the group consisting of glycidyl methacrylate, 3,4-epoxycyclohexyl methacrylate, a glycidyl ether compound having an unsaturated group, an unsaturated compound having an epoxy group and any combination thereof. The glycidyl ether compound having the unsaturated group includes but is not limited to the commercially available products such as Denacol EX-111, Denacol EX-121, Denacol EX-141, Denacol EX-145, Denacol EX-146, Denacol EX-171, Denacol EX-192 or so on manufactured by Nagase ChemteX Corporation.

In one embodiment of the invention, the aforementioned resin having the unsaturated group (A-1) can be synthesized as follows. The epoxy compound (i) having at least two epoxy groups represented by Formula (I) and the compound (ii) having at least one carboxylic acid group and at least one ethylenically unsaturated group are polymerized to form an intermediate product containing a hydroxyl group, and then the intermediate product reacts with the carboxylic anhydride compound (iii), so as to obtain the resin having the unsaturated group (A-1). Based on the total amount of the hydroxyl group as 1 equivalent, the used amount of the carboxylic anhydride compound (iii) preferably is 0.4 to 1 equivalent; more preferably 0.75 to 1 equivalent. When a plurality of the carboxylic anhydride compounds (iii) is used in this reaction, they can be added sequentially or simultaneously in the reaction. Preferably, when the dicarboxylic anhydride compound and the tetracarboxylic anhydride compound are employed as the carboxylic anhydride compound (iii), the molar ratio of dicarboxylic anhydride compound to the tetracarboxylic anhydride compound may be 1/99 to 90/10, and preferably 5/95 to 80/20. In addition, this reaction can be operated under a temperature of 50° C. to 130° C.

In other embodiment of the invention, the aforementioned the aforementioned resin having the unsaturated group (A-1) can be synthesized as follows. The epoxy compound (i) containing at least two epoxy groups represented by Formula (II) and the compound (ii) containing at least one carboxyl group and at least one ethylenically unsaturated group are polymerized to form an intermediate product containing a hydroxyl group, and then the intermediate product reacts with the carboxylic anhydride compound (iii) and/or the compound (iv) having the epoxy group, so as to obtain the aforementioned resin having the unsaturated group (A-1). Based on the total amount of the epoxy groups of the epoxy compound (i) containing at least two epoxy groups represented by Formula (II), the used amount of the compound (ii) containing at least one carboxyl group and at least one ethylenically unsaturated group is 0.8 to 1.5 equivalent; preferably 0.9 to 1.1 equivalent. Based on the total hydroxyl groups of the intermediate product containing the hydroxyl group as 100 percentage by mole (mole %), the used amount of the carboxylic anhydride compound (iii) is 10 to 100 mole %; preferably 20 to 100 mole %; more preferably 30 to 100 mole %.

During the preparation of the resin having the unsaturated group (A-1), the reaction solution is usually added with an alkaline compound as a reaction catalyst for accelerating the reaction. The reaction catalyst may be used alone or in combinations of two or more, and the reaction includes but is not limited to triphenyl phosphine, triphenyl stibine, triethylamine, triethanolamine, tetramethylammonium chloride, benzyltriethylammonium chloride or the like. Preferably, based on 100 parts by weight of the total used amount of the epoxy compound (i) containing at least two epoxy groups and the compound (ii) containing at least one carboxyl group and at least one ethylenically unsaturated group, the used amount of the reaction catalyst is 0.01 to 10 parts by weight, and preferably 0.3 to 5 parts by weight.

In addition, for the purpose of controlling the polymerization degree, a polymerization inhibitor is usually added into the reaction solution. The aforementioned polymerization inhibitor includes but is not limited to methoxyphenol, methylhydroquinone, hydroquinone, 2,6-di-t-butyl-p-cresol, phenothiazine or the like. Typically, the polymerization inhibitor may be used alone or in combinations of two or more. Based on 100 parts by weight of the total used amount of the epoxy compound (i) having at least two epoxy groups and the compound (ii) having at least one carboxyl acid group and at least one ethylenically unsaturated group, the used amount of the polymerization inhibitor is 0.01 to 10 parts by weight; preferably 0.1 to 5 parts by weight.

During the preparation of the resin having the unsaturated group (A-1), a polymerization solvent can be used if necessary. Examples of the polymerization solvent include but are not limited to alcohol compounds such as ethanol, propanol, isopropanol, butanol, isobutanol, 2-butanol, hexanol or ethylene glycol; ketone compounds such as methyl ethyl ketone or cyclohexanone; aromatic hydrocarbon compounds such as toluene or xylene; cellosolve compounds such as cellosolve or butyl cellosolve; carbitol compounds such as carbitol or butyl carbitol; propylene glycol alkyl ether compounds such as propylene glycol monomethyl ether; poly(propylene glycol)alkyl ether compounds such as di(propylene glycol) methyl ether, acetate ester compounds such as ethyl acetate, butyl acetate, ethylene glycol monoethyl ether acetate, propylene glycol methyl ether acetate and the like; alkyl lactate compounds such as ethyl lactate or butyl lactate; or dialkyl glycol ethers. The aforementioned polymerization solvent may be used alone or in combinations of two or more. An acid equivalent of the resin having an unsaturated group (A-1) is 50 mg KOH/g to 200 mg KOH/g, and preferably 60 mg KOH/g to 150 mg KOH/g.

Based on 100 parts by weight of the used amount of the alkali-soluble resin (A), the used amount of the resin having the unsaturated group (A-1) is from 30 to 100 parts by weight; preferably from 50 to 100 parts by weight; more preferably from 70 to 100 parts by weight. If the resin having the unsaturated group (A-1) is absent, the photosensitive resin composition has serious film shrinkage phenomenon.

The alkali-soluble resin (A) according to the invention can optionally include an other alkali-soluble resin (A-2). The other alkali-soluble resin (A-2) includes but is not limited to a resin containing a carboxylic group or a hydroxyl group, specifically a resin such as acrylic resin, a urethane resin, or a novolac resin other than the resin having the unsaturated group (A-1).

Based on 100 parts by weight of the used amount of the alkali-soluble resin (A), the used amount of the other alkali-soluble resin (A-2) is from 0 to 70 parts by weight; preferably from 0 to 50 parts by weight; more preferably from 0 to 30 parts by weight.

The compound containing the ethylenically unsaturated group (B) can be selected from a compound having one ethylenically unsaturated group or a compound having two or more ethylenically unsaturated groups.

The aforementioned compound having one ethylenically unsaturated group includes but is not limited to, for instance, (meth)acrylamide, (meth)acryloylmorpholine, 7-amino-3,7-dimethyloctyl(meth)acrylate, isobutoxymethyl(meth)acrylamide, isobornyloxyethyl(meth)acrylate, isobornyl(meth)acrylate, 2-ethylhexyl(meth)acrylate, ethyl diethylene glycol(meth)acrylate, t-octyl(meth)acrylamide, diacetone(meth)acrylamide, dimethylaminoethyl(meth)acrylate, dodecyl(meth)acrylate, dicyclopentenyloxyethyl(meth)acrylate, dicyclopentenyl(meth)acrylate, N,N-dimethyl(meth)acrylamide, tetrachlorophenyl(meth)acrylate, 2-tetrachlorophenoxy ethyl(meth)acrylate, tetrahydrofurfuryl(meth)acrylate, tetrabromophenyl(meth)acrylate, 2-tetrabromophenoxyethyl(meth)acrylate, 2-trichlorophenoxyethyl(meth)acrylate, tribromophenyl(meth)acrylate, 2-tribromophenoxyethyl(meth)acrylate, 2-hydroxyethyl(meth)acrylate, 2-hydroxypropyl(meth)acrylate, vinylcaprolactam, N-vinylpyrrolidone, phenoxyethyl(meth)acrylate, pentachlorophenyl(meth)acrylate, pentabromophenyl(meth)acrylate, polyethylene glycol mono(meth)acrylate, polypropylene glycol mono(meth)acrylate, or bornyl(meth)acrylate. The compound (B) containing the ethylenically unsaturated group can generally be used alone or in combination.

The compound having two or more ethylenically unsaturated groups includes but is not limited to, for instance, ethylene glycol di(meth)acrylate, dicyclopentenyl di(meth)acrylate, triethylene glycol di(meth)acrylate, tetraethylene glycol di(meth)acrylate, tri(2-hydroxyethyl)isocyanate di(meth)acrylate, tri(2-hydroxyethyl)isocyanate tri(meth)acrylate, caprolactone-modified tri(2-hydroxyethyl)isocyanate tri(meth)acrylate, trimethylolpropyl tri(meth)acrylate, ethylene oxide (referred to as EO) modified trimethylolpropyl tri(meth)acrylate, propylene oxide (referred to as PO) modified trimethylolpropyl tri(meth)acrylate, tripropylene glycol di(meth)acrylate, neo-pentyl glycol di(meth)acrylate, 1,4-butanediol di(meth)acrylate, 1,6-hexanediol di(meth)acrylate, pentaerythritol tri(meth)acrylate, pentaerythritol tetra(meth)acrylate, polyester di(meth)acrylate, polyethylene glycol di(meth)acrylate, dipentaerythritol hexa(meth)acrylate (DPHA), dipentaerythritol penta(meth)acrylate, dipentaerythritol tetra(meth)acrylate, caprolactone-modified dipentaerythritol hexa(meth)acrylate, caprolactone-modified dipentaerythritol penta(meth)acrylate, ditrimethylolpropyl tetra(meth)acrylate, EO-modified bisphenol A di(meth)acrylate, PO-modified bisphenol A di(meth)acrylate, EO-modified hydrogenated bisphenol A di(meth)acrylate, PO-modified hydrogenated bisphenol A di(meth)acrylate, PO-modified glycerol tri(meth)acrylate, EO-modified bisphenol F di(meth)acrylate, or phenol novolac polyglycidyl ether(meth)acrylate. The compound (B) having two or more ethylenically unsaturated groups can generally be used alone or in combination.

Examples of the aforementioned compound (B) containing the ethylenically unsaturated group are, for instance, trimethylolpropyl triacrylate, EO-modified trimethylolpropyl triacrylate, PO-modified trimethylolpropyl triacrylate, pentaerythritol triacrylate, pentaerythritol tetraacrylate, dipentaerythritol hexaacrylate, dipentaerythritol pentaacrylate, dipentaerythritol tetraacrylate, caprolactone-modified dipentaerythritol hexaacrylate, ditrimethylolpropyl tetraacrylate, PO-modified glycerol triacrylate, or any combination thereof.

Based on 100 parts by weight of the used amount of the alkali-soluble resin (A), the used amount of the compound (B) containing the ethylenically unsaturated group is from 40 to 300 parts by weight; preferably from 50 to 250 parts by weight; more preferably from 60 to 200 parts by weight.

The photoinitiator (C) according to the invention is not particularly limited, and includes but is not limited to O-oxime compound, triazine compound, acetophenone compound, biimidazole compound, benzophenone compound, α-diketone compound, ketone alcohol compound, ketone alcohol ether compound, acylphosphine oxide compound, quinone compound, halogen-containing compound, peroxide or the like.

Examples of the aforementioned O-oxime compound are 1-[4-(phenylthio)phenyl]-heptane-1,2-dione 2-(O-benzoyloxime), 1-[4-(phenylthio)phenyl]-octane-1,2-dione 2-(O-benzoyloxime), 1-[4-(benzoyl)phenyl]-octane-1,2-dione 2-(O-benzoyloxime), 1-[9-ethyl-6-(2-methylbenzoyl)-9H-carbazol-3-yl]-ethanone 1-(O-acetyloxime), 1-[9-ethyl-6-(3-methylbenzoyl)-9H-carbazol-3-yl]-ethanone 1-(O-acetyloxime), 1-[9-ethyl-6-benzoyl-9H-carbazol-3-yl]-ethanone 1-(O-acetyloxime), ethanone-1-[9-ethyl-6-(2-methyl-4-(tetrahydrofuran)benzoyl)-9H-carbazol-3-yl]-1-(O-acetyloxime), ethanone-1-[9-ethyl-6-(2-methyl-4-(tetrahydropyranyl)benzoyl)-9H-carbazol-3-yl]-1-(O-acetyloxime), ethanone-1-[9-ethyl-6-(2-methyl-5-(tetrahydrofuran)benzoyl)-9H-carbazol-3-yl]-1-(O-acetyloxime), ethanone-1-[9-ethyl-6-(2-methyl-5-(tetrahydropyranyl)benzoyl)-9H-carbazol-3-yl]-1-(O-acetyloxime), ethanone-1-[9-ethyl-6-(2-methyl-4-(tetrahydrofuran)methoxybenzoyl)-9H-carbazol-3-yl]-1-(O-acetyloxime), ethanone-1-[9-ethyl-6-(2-methyl-4-(tetrahydropyranyl) methoxybenzoyl)-9H-carbazol-3-yl]-1-(O-acetyloxime), ethanone-1-[9-ethyl-6-(2-methyl-5-(tetrahydrofuran)methoxybenzoyl)-9H-carbazol-3-yl]-1-(O-acetyloxime), ethanone-1-[9-ethyl-6-(2-methyl-5-(tetrahydropyranyl) methoxybenzoyl)-9H-carbazol-3-yl]-1-(O-acetyloxime), ethanone-1-[9-ethyl-6-{2-methyl-4-(2,2-dimethyl-1,3-dioxolan)benzoyl}-9H-carbazol-3-yl]-1-(O-acetyloxime), ethanone-1-[9-ethyl-6-{2-methyl-4-(2,2-dimethyl-1,3-dioxolan)methoxybenzoyl}-9H-carbazol-3-yl]-1-(O-acetyloxime) or the like.

Preferably, the O-oxime compound is 1-[4-(phenylthio)phenyl]-octane-1,2-dione 2-(O-benzoyloxime) (such as OXE-01 manufactured by Ciba Specialty Chemicals), 1-[9-ethyl-6-(2-methylbenzoyl)-9H-carbazol-3-yl]-ethanone 1-(O-acetyloxime) (such as OXE-02 manufactured by Ciba Specialty Chemicals), ethanone-1-[9-ethyl-6-(2-methyl-4-(tetrahydropyranyl) methoxybenzoyl)-9H-carbazol-3-yl]-1-(O-acetyloxime), ethanone-1-[9-ethyl-6-{2-methyl-4-(2,2-dimethyl-1,3-dioxolan)methoxybenzoyl}-9H-carbazol-3-yl]-1-(O-acetyloxime) or the like. The O-oxime compound can be used alone or in combination, depending on actual demand.

The triazine compound includes but is not limited to a vinyl-halogenated methyl-s-triazine compound, a 2-(naphtho-1-yl)-4,6-bis-halogenated methyl-s-triazine compound, a 4-(p-aminophenyl)-2,6-di-halogenated methyl-s-triazine compound or the like.

Examples of the aforementioned vinyl-halogenated methyl-s-triazine compound are 2,4-bis(trichloromethyl)-6-(p-methoxy)styryl-s-triazine, 2,4-bis(trichloromethyl)-3-(1-p-dimethylaminophenyl-1,3-butadienyl)-s-triazine, 2-trichloromethyl-3-amino-6-(p-methoxy) styryl-s-triazine or the like.

Examples of the aforementioned 2-(naphtho-1-yl)-4,6-bis-halogenated methyl-s-triazine compound are 2-(naphtho-1-yl)-4,6-bistrichloromethyl-s-triazine, 2-(4-methoxy-naphtho-1-yl)-4,6-bistrichloromethyl-s-triazine, 2-(4-ethoxy-naphtho-1-yl)-4,6-bis-trichloromethyl-s-triazine, 2-(4-butoxy-naphtho-1-yl)-4,6-bistrichloromethyl-s-triazine, 2-[4-(2-methoxyethyl)-naphtho-1-yl]-4,6-bis-trichloromethyl-s-triazine, 2-[4-(2-ethoxyethyl)-naphtho-1-yl]-4,6-bis-trichloromethyl-s-triazine, 2-[4-(2-butoxyethyl)-naphtho-1-yl]-4,6-bistrichloromethyl-s-triazine, 2-(2-methoxy-naphtho-1-yl)-4,6-bistrichloromethyl-s-triazine, 2-(6-methoxy-5-methyl-naphtho-2-yl)-4,6-bis-trichloromethyl-s-triazine, 2-(6-methoxynaphtho-2-yl)-4,6-bistrichloromethyl-s-triazine, 2-(5-methoxy-naphto-1-yl)-4,6-bistrichloromethyl-s-triazine, 2-(4,7-dimethoxy-naphtho-1-yl)-4,6-bistrichloromethyl-s-triazine, 2-(6-ethoxy-naphtho-2-yl)-4,6-bistrichloromethyl-s-triazine, 2-(4,5-dimethoxy-naphtho-1-yl)-4,6-bistrichloromethyl-s-triazine or the like.

Examples of the aforementioned 4-(p-aminophenyl)-2,6-di-halogenated methyl-s-triazine compound are 4-[p-N,N-di(ethoxycarbonylmethyl)aminophenyl]-2,6-di(trichloromethyl)-s-triazine, 4-[o-methyl-p-N,N-di(ethoxycarbonylmethyl)aminophenyl]-2,6-di(trichloromethyl)-s-triazine, 4-[p-N,N-di(chloroethyl)aminophenyl]-2,6-di(trichloromethyl)-s-triazine, 4-[o-methyl-p-N,N-di(chloroethyl)aminophenyl]-2,6-di(trichloromethyl)-s-triazine, 4-(p-N-chloroethylaminophenyl)-2,6-di(trichloromethyl)-s-triazine, 4-(p-N-ethoxycarbonylmethylaminophenyl)-2,6-di(trichloromethyl)-s-triazine, 4-[p-N,N-di(phenyl)aminophenyl]-2,6-di(trichloromethyl)-s-triazine, 4-(p-N-chloroethylcarbonylaminophenyl)-2,6-di(trichloromethyl)-s-triazine, 4-[p-N-(p-methoxyphenyl)carbonylaminophenyl]-2,6-di(trichloromethyl)-s-triazine, 4-[m-N,N-di(ethoxycarbonylmethyl)aminophenyl]-2,6-di(trichloromethyl)-s-triazine, 4-[m-bromo-p-N,N-di(ethoxycarbonylmethyl)aminophenyl]-2,6-di(trichloromethyl)-s-triazine, 4-[m-chloro-p-N,N-di(ethoxycarbonylmethyl)aminophenyl]-2,6-di(trichloromethyl)-s-triazine, 4-[m-fluoro-p-N,N-di(ethoxycarbonylmethyl)aminophenyl]-2,6-di(trichloromethyl)-s-triazine, 4-[o-bromo-p-N,N-di(ethoxycarbonylmethyl)aminophenyl]-2,6-di(trichloromethyl)-s-triazine, 4-[o-chloro-p-N,N-di(ethoxycarbonylmethyl)aminophenyl-2,6-di(trichloromethyl)-s-triazine, 4-[o-fluoro-p-N,N-di(ethoxycarbonylmethyl)aminophenyl]-2,6-di(trichloromethyl)-s-triazine, 4-[o-bromo-p-N,N-di(chloroethyl)aminophenyl]-2,6-di(trichloromethyl)-s-triazine, 4-[o-chloro-p-N,N-di(chloroethyl)aminophenyl]-2,6-di(trichloromethyl)-s-triazine, 4-[o-fluoro-p-N,N-di(chloroethyl)aminophenyl]-2,6-di(trichloromethyl)-s-triazine, 4-[m-bromo-p-N,N-di(chloroethyl)aminophenyl]-2,6-di(trichloromethyl)-s-triazine, 4-[m-chloro-p-N,N-di(chloroethyl)aminophenyl]-2,6-di(trichloromethyl)-s-triazine, 4-[m-fluoro-p-N,N-di(chloroethyl)aminophenyl]-2,6-di(trichloromethyl)-s-triazine, 4-(m-bromo-p-N-ethoxycarbonylmethylaminophenyl)-2,6-di(trichloromethyl)-s-triazine, 4-(m-chloro-p-N-ethoxycarbonylmethylaminophenyl)-2,6-di(trichloromethyl)-s-triazine, 4-(m-fluoro-p-N-ethoxycarbonylmethylaminophenyl)-2,6-di(trichloromethyl)-s-triazine, 4-(o-bromo-p-N-ethoxycarbonylmethylaminophenyl)-2,6-di(trichloromethyl)-s-triazine, 4-(o-chloro-p-N-ethoxycarbonylmethylaminophenyl)-2,6-di(trichloromethyl)-s-triazine, 4-(o-fluoro-p-N-ethoxycarbonylmethylaminophenyl)-2,6-di(trichloromethyl)-s-triazine, 4-(m-bromo-p-N-chloroethylaminophenyl)-2,6-di(trichloromethyl)-s-triazine, 4-(m-chloro-p-N-chloroethylaminophenyl)-2,6-di(trichloromethyl)-s-triazine, 4-(m-fluoro-p-N-chloroethylaminophenyl)-2,6-di(trichloromethyl)-s-triazine, 4-(o-bromo-p-N-chloroethylaminophenyl)-2,6-di(trichloromethyl)-s-triazine, 4-(o-chloro-p-N-chloroethylaminophenyl)-2,6-di(trichloromethyl)-s-triazine, 4-(o-fluoro-p-N-chloroethylaminophenyl)-2,6-di(trichloromethyl)-s-triazine, and 2,4-di(trichloromethyl)-6-[3-bromo-4-[N,N-di(ethoxycarbonylmethyl)amino]phenyl]-1,3,5-triazine.

The triazine compound preferably is 4-[m-bromo-p-N,N-di(ethoxycarbonylmethyl)aminophenyl]-2,6-di(trichloromethyl)-s-triazine, 2,4-bis(trichloromethyl)-6-p-methoxystyryl-s-triazine or the like. The triazine compound can be used alone or in combination, depending on actual demand.

Examples of the aforementioned acetophenone compound are p-dimethylamino-acetophenone, α,α′-dimethoxyazoxy-acetophenone, 2,2′-dimethyl-2-phenyl-acetophenone, p-methoxy-acetophenone, 2-methyl-1-(4-methylthio phenyl)-2-morpholino-1-propanone (such as IRGACURE 907 manufactured by Ciba Specialty Chemicals), or 2-benzyl-2-N,N-dimethylamino-1-(4-morpholinophenyl)-1-butanone. The acetophenone compound preferably is 2-methyl-1-4-(methylthiophenyl)-2-morpholino-1-propanone or 2-benzyl-2-N,N-dimethylamino-1-(4-morpholinophenyl)-1-butanone. The acetophenone compound can be used alone or in combination, depending on actual demand.

Examples of the aforementioned biimidazole compound are 2,2′-bis(o-chlorophenyl)-4,4′,5,5′-tetraphenyl-biimidazole, 2,2′-bis(o-fluorophenyl)-4,4′,5,5′-tetraphenyl-biimidazole, 2,2′-bis(o-methyl phenyl)-4,4′,5,5′-tetraphenyl-biimidazole, 2,2′-bis(o-methoxyphenyl)-4,4′,5,5′-tetraphenyl-biimidazole, 2,2′-bis(o-ethylphenyl)-4,4′,5,5′-tetraphenyl-biimidazole, 2,2′-bis(p-methoxyphenyl)-4,4′,5,5′-tetraphenyl-biimidazole, 2,2′-bis(2,2′,4,4′-tetramethoxyphenyl)-4,4′,5,5′-tetraphenyl-biimidazole, 2,2′-bis(2-chlorophenyl)-4,4′,5,5′-tetraphenyl-biimidazole, or 2,2′-bis(2,4-dichlorophenyl)-4,4′,5,5′-tetraphenyl-biimidazole. The biimidazole compound is preferably 2,2′-bis(2,4-dichlorophenyl)-4,4′,5,5′-tetraphenyl-biimidazole. The biimidazole compound can be used alone or in combination, depending on actual demand.

Examples of the aforementioned benzophenone compound are thioxanthone, 2,4-diethylthioxanthone, thioxanthone-4-sulfone, benzophenone, 4 4′-bis(dimethylamino)benzophenone, and 4,4′-bis(diethylamino)benzophenone. The benzophenone compound is preferably 4,4′-bis(diethylamino)benzophenone. The benzophenone compound can be used alone or in combination, depending on actual demand.

Examples of the aforementioned α-diketone compound are benzil or acetyl. The ketone alcohol compound is, for instance, benzoin. The ketone alcohol ether compound is, for instance, benzoin methyl ether, benzoin ethyl ether, or benzoin iso-propyl ether. The acylphosphine oxide compound is, for instance, 2,4,6-trimethylbenzoyl diphenyl phosphine oxide or bis-(2,6-dimethoxybenzoyl)-2,4,4-trimethyl benzyl phosphine oxide. The quinone compound is, for instance, anthraquinone or 1,4-naphthoquinone. The halogen-containing compound is, for instance, phenacyl chloride, tribromomethyl phenylsulfone, or tri(trichloromethyl)-s-triazine. The peroxide compound is, for instance, di-tert-butyl peroxide. The α-diketone compound, ketone alcohol compound, ketone alcohol ether compound, acylphosphine oxide compound, quinone compound, halogen-containing compound, and peroxide compound can be used individually or in combination, depending on actual demand.

The used amount of the photoinitiator (C) according to the invention can be adjusted depending on demand. Based on 100 parts by weight of the used amount of the alkali-soluble resin (A), the used amount of the photoinitiator (C) is from 10 to 80 parts by weight; preferably 12 to 75 parts by weight; more preferably 15 to 70 parts by weight.

The solvent (D) according to the invention is preferably able to dissolve the alkali-soluble resin (A), the compound (B) containing the ethylenically unsaturated group, the photoinitiator (C), and the epoxy resin (G) containing the fluorene skeleton represented by Formula (b), without interacting with the components described above, and has a suitable volatility.

Examples of the aforementioned solvent (D) are an alkylene glycol monoalkyl ether compound such as ethylene glycol monomethyl ether, ethylene glycol monoethyl ether, diethylene glycol monoethyl ether, diethylene glycol mono-n-propyl ether, diethylene glycol mono-n-butyl ether, triethylene glycol monomethyl ether, triethylene glycol monoethyl ether, propylene glycol monomethyl ether, propylene glycol monoethyl ether, dipropylene glycol monomethyl ether, dipropylene glycol monoethyl ether, dipropylene glycol mono-n-propyl ether, dipropylene glycol mono-n-butyl ether, tripropylene glycol monomethyl ether, or tripropylene glycol monoethyl ether; alkylene glycol monoalkyl ether acetate compounds such as ethylene glycol methyl ether acetate, ethylene glycol ethyl ether acetate, propylene glycol methyl ether acetate, or propylene glycol ethyl ether acetate; other ether compounds such as diethylene glycol dimethyl ether, diethylene glycol methyl ethyl ether, diethylene glycol diethyl ether, or tetrahydrofuran; ketone compounds such as methyl ethyl ketone, cyclohexanone, 2-heptanone, or 3-heptanone or diacetone alcohol; alkyl lactate compounds such as methyl lactate or ethyl lactate; other ester compounds such as methyl 2-hydroxy-2-methylpropanoate, ethyl 2-hydroxy-2-methylpropanoate, methyl 3-methoxypropanoate, ethyl 3-methoxypropanoate, methyl 3-ethoxypropanoate, ethyl 3-ethoxypropanoate, ethyl ethoxyacetate, ethyl hydroxyacetate, methyl 2-hydroxy-3-methylbutyrate, 3-methyl-3-methoxybutyl acetate, 3-methyl-3-methoxybutyl propanoate, ethyl acetate, n-propyl acetate, isopropyl acetate, n-butyl acetate, isobutyl acetate, n-amyl acetate, isoamyl acetate, n-butyl propanoate, ethyl butyrate, n-propyl butyrate, isopropyl butyrate, n-butyl butyrate, methyl pyruvate, ethyl pyruvate, n-propyl pyruvate, methyl acetoacetate, ethyl acetoacetate, or ethyl 2-oxybutyrate; aromatic hydrocarbons such as toluene or xylene; carboxylic amines such as N-methylpyrrolidone, N,N-dimethylformamide, or N,N-dimethylacetamide; or any combination thereof. The solvent (D) can generally be used alone or in combination.

Based on 100 parts by weight of the used amount of the alkali-soluble resin (A), the used amount of the solvent (D) is from 1200 to 8000 parts by weight; preferably 1500 to 7500 parts by weight; more preferably 1800 to 7000 parts by weight.

The black pigment (E) suitable for the invention is preferably a black pigment having heat-resistance, light-resistance, and solvent-resistance.

Examples of the aforementioned black pigment (E) are an organic black pigment such as perylene black, cyanine black, or aniline black; a near-black mixture of organic pigments obtained by mixing two or more organic pigments selected from, for instance, red, blue, green, purple, yellow, cyanine, and magenta pigment; a shading material such as carbon black, chromium oxide, ferric oxide, titanium black, or graphite, wherein the carbon black can include but is not limited to C.I. pigment black 7, such as products manufactured by Mitsubishi Chemical Co. (product names MA100, MA230, MA8, #970, #1000, #2350, and #2650). The black pigment (E) can generally be used alone or in combination.

Based on 100 parts by weight of the used amount of the alkali-soluble resin (A), the used amount of the black pigment (E) is from 100 to 700 parts by weight; preferably 120 to 650 parts by weight; more preferably 150 to 600 parts by weight.

The photosensitive resin composition for the black matrix according to the invention comprises the compound (F) represented by Formula (a);

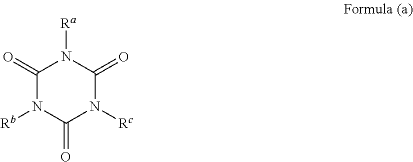

wherein in Formula (a):

R^{a}, R^{b} and R^{c} each independently represent a trialkoxysilyl group linked to an alkylene group or an arylene group.

The alkylene group or the arylene group can have a substituted group, wherein the substituted group can be an amino group, a hydrocarbyl group, an alkoxy group or a halogen atom.

Specific examples of the alkylene according to the invention are a C₁-C₁₀ arylene group such as a methylene group, an ethylidene group, a propylidene group, a butylidene group, a pentylidene group, a hexylidene group, a heptylidene group, an octylidene group, a nonylidene group, or a decylidene group. Specific examples of the arylene group are phenylene or naphthylene.

Specific examples of the compound (F) are represented by the following Formulae (a-1) to (a-9):

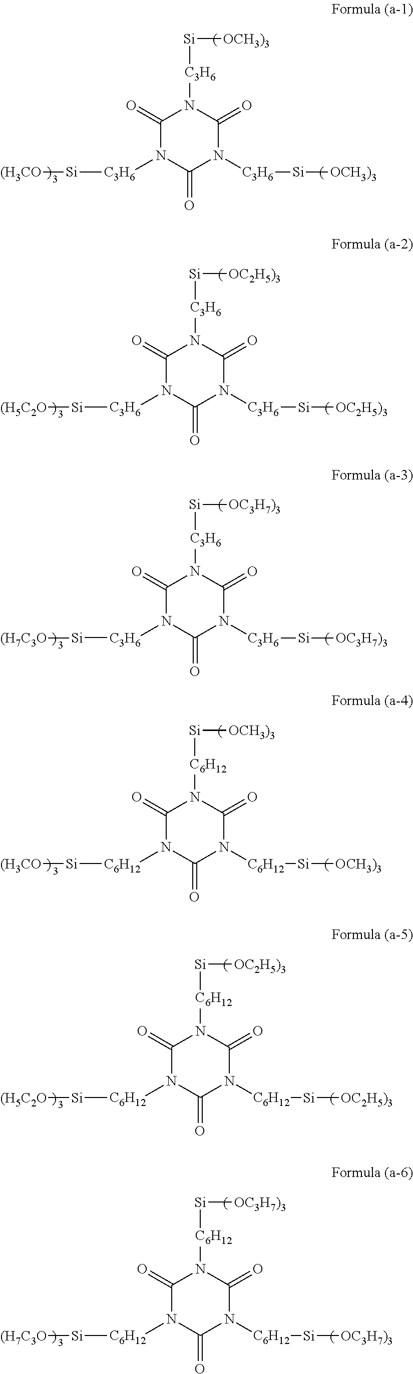

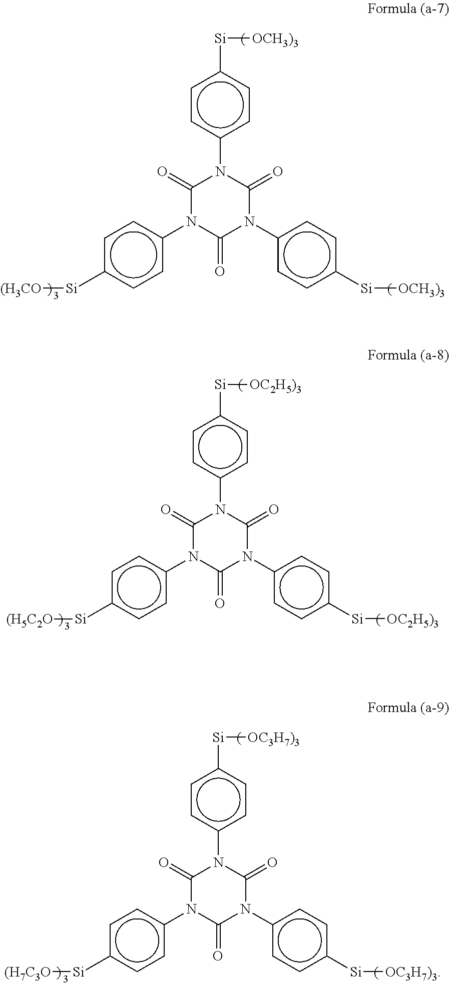

The compound represented by Formula (a) is preferably Formula (a-1), Formula (a-4), Formula (a-7) or Formula (a-9).

Based on 100 parts by weight of the used amount of the alkali-soluble resin (A), the used amount of the compound (F) represented by Formula (a) is from 5 to 40 parts by weight; preferably from 6 to 35 parts by weight; more preferably from 7 to 30 parts by weight.

If the compound (F) represented by Formula (a) is absent, the photosensitive resin composition has serious film shrinkage phenomenon. Though not willing to be limited by theory, it is believed that because the compound (F) represented by Formula (a) and other black photoresist composition carry out crosslinking, it can reduce the film shrinkage.

The epoxy resin (G) containing the fluorene skeleton according to the invention is represented by Formula (b), wherein:

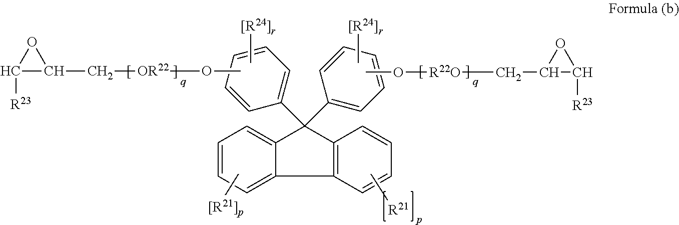

in Formula (b):

R²¹ represents a cyano group, a C₁-C₅ alkyl group or a halogen atom;

R²² represents a C₁-C₁₃ alkylene group;

R²³ represents a hydrogen atom or a methyl group;

R²⁴ represents a C₁-C₅ alkyl group, a C₆-C₁₂ aryl group or a C₆-C₁₂ aralkyl group;

p represents an integer from 0 to 4;

q represents an integer from 1 to 10; and

r represents an integer from 0 to 4.

The aforementioned epoxy resin (G) containing the fluorene skeleton represented by Formula (b) can be obtained by reacting epihalohydrin such as epichlorohydrin, alcohol, or phenol and a fluorene skeleton in the presence of an alkali metal hydroxide.

Specific examples of the epoxy resin (G) containing the fluorene skeleton represented by Formula (b) are 9,9-bis(glycidyloxyphenyl(poly)alkoxyphenyl, such as 9,9-bis[4-(2-glycidyloxyethoxy)phenyl]fluorene; 9,9-bis(alkyl-glycidyloxyphenyl(poly)alkoxyphenyl)fluorene, such as 9,9-bis[4-(2-glycidyloxyethoxy)-3-methylphenyl]fluorene, or 9,9-bis[4-(2-glycidyloxyethoxy)-3,5-dimethylphenyl]fluorene; 9,9-bis(aryl-glycidyloxyphenyl(poly)alkoxyphenyl)fluorene, such as 9,9-bis[4-(2-glycidyloxyethoxy)-3-phenylphenyl]fluorene.

Specific examples of the epoxy resin (G) containing the fluorene skeleton represented by Formula (b) are EG-200, EG-250, or PG-100 manufactured by Osaka Gas Co., Ltd.

Based on 100 parts by weight of the used amount of the alkali-soluble resin (A), the used amount of the epoxy resin (G) containing the fluorene skeleton represented by Formula (b) is from 3 to 30 parts by weight; preferably from 4 to 27 parts by weight; more preferably from 5 to 25 parts by weight.

If the epoxy resin (G) containing the fluorene skeleton represented by Formula (b) is absent, the roughness is poor.

Preferably, the photosensitive resin composition according to the invention further comprises a polysiloxane (H) having an acid anhydride group or an epoxy group.

The polysiloxane (H) having the acid anhydride group or the epoxy group is obtained by subjecting a reactant to a polymerization reaction (that is hydrolysis and partial condensation), and the reactant includes a silane monomer, a siloxane prepolymer, or a combination thereof.

The monomer used in polymerization of the polysiloxane (H) having the acid anhydride group or the epoxy group includes at least one silane monomer having a structure of Formula (III):

Si(R²⁵)ₜ(OR²⁶)₄₋ₜ Formula (III),

t represents an integer from 1 to 3; when t represents 2 or 3, a plurality of R²⁵ are independently the same or different; and when 4-t represents 2 or 3, a plurality of R²⁶ are independently the same or different;

at least one of R²⁵ represents a C₁-C₁₀ alkyl group substituted by an acid anhydride group, a C₁-C₁₀ alkyl group substituted by an epoxy group or an alkoxy group substituted by an epoxy group; and the remaining R²⁵ represent a hydrogen atom, a C₁-C₁₀ alkyl group, a C₂-C₁₀ alkenyl group or a C₆-C₁₅ aromatic group; and R²⁶ represents a hydrogen atom, a C₁-C₆ alkyl group, a C₁-C₆ acyl group or a C₆-C₁₅ aromatic group.

Specific examples of the C₁-C₁₀ alkyl group substituted by the acid anhydride group are ethyl succinic anhydride, propyl succinic anhydride, propyl glutaric anhydride, or the like.

Specific examples of the C₁-C₁₀ alkyl group substituted by the epoxy group are oxetanylpentyl, 2-(3,4-epoxycyclohexyl)ethyl, or the like.

Specific examples of the alkoxy group substituted by the epoxy group are glycidoxypropyl, 2-oxetanylbutoxy, or the like.

In R²⁶, the aforementioned alkyl group includes but is not limited to a methyl group, ethyl group, n-propyl group, isopropyl group, n-butyl group, or the like. The acyl group may include, but not limited to, an acetyl group. The aryl group may include, but not limited to, a benzyl group.

The silane monomer having the structure represented by Formula (III) includes but is not limited 3-glycidoxypropyltrimethoxysilane (TMS-GAA), 3-glycidoxypropyltriethoxysilane, 2-(3,4-epoxycyclohexyl)ethyltrimethoxy silane, 2-oxetanylbutoxypropyltriphenoxysilane, 3-(triphenoxysilyl)propyl succinic anhydride, 3-(trimethoxysilyl)propyl glutaric anhydride (TMSG), 3-(triethoxysilyl)propyl glutaric anhydride, 3-(triphenoxysilyl)propyl glutaric anhydride, diisopropoxy-di(2-oxetanylbutoxypropyl)silane (DIDOS), di(3-oxetanylpentyl)dimethoxysilane, (di-n-butoxysilyl)di(propylsuccinic anhydride), (dimethoxysilyl)di(ethylsuccinic anhydride), 3-glycidoxypropyldimethylmethoxysilane, 3-glycidoxypropyldimethylethoxysilane, di(2-oxetanylbutoxypentyl)-2-oxetanylpentylethoxysilane, tri(2-oxetanylpentyl)methoxysilane, (phenoxysilyl)tri(propyl succinic anhydride), (methylmethoxysilyl)di(ethyl succinic anhydride); commercially available 2-oxetanylbutoxypropyltrimethoxysilane (the trade name is TMSOX-D), 2-oxetanybutoxypropyltriethoxysilane (the trade name is TESOX-D), 3-ethyl-3-{[3-(trimethoxysilyl)propoxy]methyl}epoxypropane (the trade name is TMSOX) manufactured by Toagosei Co. Ltd.; commercially available 3-trimethoxysilylpropyl succinic anhydride (the trade name is X-12-967) manufactured by Shin-Etsu Chemical Co., Ltd.; and commercially available 3-(triethoxysilyl)propyl succinic anhydride (the trade name is GF-20) manufactured by Wacker Chemie AG, or the like. The aforementioned silane monomer having the structure represented by Formula (III) can be used alone or in admixture of two or more thereof.

Preferably, the silane monomer includes but is not limited to a silane monomer having a structure represented by Formula (III-1):

Si(R²⁷)ᵤ(OR²⁸)₄₋ᵤ Formula (III-1)

wherein:

R²⁷ is selected from a group consisting of a hydrogen atom, a C₁-C₁₀ alkyl group, a C₂-C₁₀ alkenyl group and a C₆-C₁₅ aryl group, wherein the C₁-C₁₀ alkyl group does not comprise an acid anhydride substituent;

R²⁸ is independently selected from a group consisting of a hydrogen atom, a C₁-C₆ alkyl group, a C₁-C₆ acyl group and a C₆-C₁₅ aryl group; and

u represents an integer from 1 to 3; when u represents 2 or 3, a plurality of R²⁷ are independently the same or different; and when 4-u represents 2, 3 or 4, a plurality of R²⁸ are independently the same or different.

In R²⁷, the alkyl group includes but is not limited to a methyl group, ethyl group, n-propyl group, isopropyl group, n-butyl group, tert-butyl group, n-hexyl group, n-decyl group, trifluoromethyl group, 3,3,3-trifluoropropyl group, 3-aminopropyl group, 3-mercaptopropyl group, 3-isocyanatopropyl group, or the like. The alkenyl group includes but is not limited to a vinyl group, 3-acryloxypropyl group, 3-methacryloxypropyl group, or the like. The aryl group includes but is not limited to a phenyl group, tolyl group, p-hydroxyphenyl group, 1-(p-hydroxyphenyl)ethyl group, 2-(p-hydroxyphenyl)ethyl group, 4-hydroxy-5-(p-hydroxyphenylcarbonyloxy)pentyl group, naphthyl group, or the like.

In R²⁸, the alkyl group includes but is not limited to a methyl group, ethyl group, n-propyl group, isopropyl group, n-butyl group, or the like. The acyl group includes but is not limited to an acetyl group. The aryl group includes but is not limited to a phenyl group.

The silane monomer having the structure represented by Formula (III-1) includes but is not limited to tetramethoxysilane, tetraethoxysilane, tetraacetoxysilane, tetraphenoxysilane, methyltrimethoxysilane, methyltriethoxysilane, methyltriisopropoxysilane, methyltri-n-butoxysilane, ethyltrimethoxysilane, ethyltriethoxysilane, ethyltriisopropoxysilane, ethyltri-n-butoxysilane, n-propyltrimethoxysilane, n-propyltriethoxysilane, n-butyltrimethoxysilane, n-butyltriethoxysilane, n-hexyltrimethoxysilane, n-hexyltriethoxysilane, decyltrimethoxysilane, vinyltrimethoxysilane, vinyltriethoxysilane, phenyltrimethoxysilane, phenyltriethoxysilane, p-hydroxyphenyltrimethoxysilane, 1-(p-hydroxyphenyl)ethyltrimethoxysilane, 2-(p-hydroxyphenyl)ethyltrimethoxysilane, 4-hydroxy-5-(p-hydroxyphenylcarbonyloxy)pentyltrimethoxysilane, trifluoromethyltrimethoxysilane, trifluoromethyltriethoxysilane, 3,3,3-trifluoropropyltrimethoxysilane, 3-aminopropyltrimethoxysilane, 3-aminopropyltriethoxysilane, dimethyldimethoxysilane, dimethyldiethoxysilane, dimethyldiacetyloxysilane, di-n-butyldimethoxysilane, diphenyldimethoxysilane, trimethylmethoxysilane, tri-n-butylethoxysilane, 3-mercaptopropyltrimethoxysilane, 3-acryloxypropyltrimethoxysilane, 3-methylacryloxypropyltrimethoxysilane, 3-methylacryloxypropyltriethoxysilane, or the like. The aforementioned silane monomer having the structure represented by Formula (III-1) can be used alone or in admixture of two or more thereof.

Preferably, the aforementioned reactant for polysiloxane (H) having the acid anhydride group or the epoxy group can selectively include a siloxane prepolymer having a structure represented by Formula (III-2):

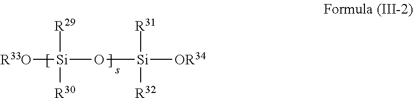

wherein:

R²⁹, R³⁰, R³¹ and R³² are the same or different, and are independently selected from a group consisting of a hydrogen atom, a C₁-C₁₀ alkyl group, a C₂-C₆ alkenyl group and a C₆-C₁₅ aryl group; wherein preferably, the alkyl group, the alkenyl group or the aryl group comprises a substituted group; wherein each of R²⁹ is the same or different, and each of R³⁰ is the same or different; the aforementioned alkyl group includes but is not limited to a methyl group, ethyl group, n-propyl group, or the like. The aforementioned alkenyl group includes but not is limited to a vinyl group, acryloxypropyl group, methacryloxypropyl group, or the like. The aforementioned aryl group includes but is not limited to a phenyl group, tolyl group, naphthyl group, or the like.

s represents an integer from 1 to 1000; preferably, s represents an integer from 3 to 300; more preferably, s represents an integer from 5 to 200.

R³³ and R³⁴ are independently selected from a group consisting of a hydrogen atom, a C₁-C₆ alkyl group, a C₁-C₆ acyl group and a C₆-C₁₅ aryl group; wherein preferably, the alkyl group, the aryl group or the aryl group comprises a substituted group. Preferably, the alkyl group includes but is not limited to a methyl group, ethyl group, n-propyl group, isopropyl group, n-butyl group, or the like. The acyl group includes but is not limited to an acetyl group. The aryl group includes but is not limited to a phenyl group.

The siloxane prepolymer having the structure represented by Formula (III-2) includes but is not limited to 1,1,3,3-tetramethyl-1,3-dimethoxydisiloxane, 1,1,3,3-tetramethyl-1,3-diethoxydisiloxane, 1,1,3,3-tetraethyl-1,3-diethoxydisiloxane or commercially available silanol terminal polysiloxanes manufactured by Gelest Inc., for example, DM-S12 (molecular weight: 400-700), DMS-S15 (molecular weight: 1,500-2,000), DMS-S21 (molecular weight: 4,200), DMS-S27 (molecular weight: 18,000), DMS-S31 (molecular weight: 26,000), DMS-S32 (molecular weight: 36,000), DMS-S33 (molecular weight: 43,500), DMS-S35 (molecular weight: 49,000), DMS-S38 (molecular weight: 58,000), DMS-S42 (molecular weight: 77,000), PDS-9931 (molecular weight: 1,000-1,400), or the like. The aforementioned polysiloxane having the structure represented by Formula (III-2) can be used alone or in admixture of two or more thereof.

Preferably, the aforementioned reactant can selectively include silicon dioxide particles. There is no specific limitation to the mean particle size of the silicon dioxide particles, and the mean particle size is from 2 nm to 250 nm, preferably is from 5 nm to 200 nm and more preferably is from 10 nm to 100 nm.

The silicon dioxide particles include but are not limited to commercially available products manufactured by JGC Catalysts and Chemicals Ltd., and the trade names are OSCAR 1132 (particle size: 12 nm, dispersant: methanol), OSCAR 1332 (particle size: 12 nm, dispersant: n-propanol), OSCAR 105 (particle size 60 nm, dispersant: γ-butyrolactone), OSCAR 106 (particle size: 120 nm, dispersant: diacetone alcohol), or the like; commercially available products manufactured by Fuso Chemical Co., Ltd., and the trade names are Quartron PL-1-IPA (particle size: 13 nm, dispersant: isopropanone), Quartron PL-1-TOL (particle size: 13 nm, dispersant: toluene), Quartron PL-2L-PGME (particle size: 18 nm, dispersant: propylene glycol monomethyl ether), Quartron PL-2L-MEK (particle size: 18 nm, dispersant: methyl ethyl ketone), or the like; and commercially available products manufactured by Nissan Chemical Co. Ltd., and the trade names are IPA-ST (particle size: 12 nm, dispersant: isopropanol), EG-ST (particle size: 12 nm, dispersant: ethylene glycol), IPA-ST-L (particle size: 45 nm, dispersant: isopropanol), IPA-ST-ZL (particle size: 100 nm, dispersant: isopropanol), or the like. The aforementioned examples of the silicon dioxide particles can be used alone or in admixture of two or more thereof.

The aforementioned partial condensation can be performed in a manner well known in the art. For example, a solvent, water, and optionally a catalyst are added to the silane monomer, followed by stirring at 50° C. to 150° C. for 0.5 to 120 hours. During stirring, the by-products (such as alcohols and water) can be removed by distillation.

Based on 100 g of the used amount of the silane monomer, the used amount of the solvent is 15 g to 1200 g, preferably is 20 g to 1100 g, and more preferably is 30 g to 1000 g.

Based on the hydrolysable groups in the silane monomer as 1 mole, the amount of water used for the hydrolysis is 0.5 moles to 2 moles.

There is no specific limitation to the aforementioned catalyst, and preferably an acid catalyst or a base catalyst can be selected. The acid catalyst may include, but not limited to, hydrochloric acid, nitric acid, sulfuric acid, hydrofluoric acid, oxalic acid, phosphoric acid, acetic acid, trifluoroacetic acid, formic acid, polycarboxylic acids or anhydrides thereof, ion exchange resins, or the like. The base catalyst may include, but not limited to, diethylamine, triethylamine, tripropylamine, tributylamine, tripentylamine, trihexylamine, triheptylamine, trioctylamine, diethanolamine, triethanolamine, sodium hydroxide, potassium hydroxide, alkoxysilanes having an amino group, ion exchange resins, or the like.

Based on the silane monomer as 100 g, the amount of the catalyst is 0.005 g to 15 g, preferably is 0.01 g to 12 g, and more preferably is 0.05 g to 10 g.

In view of the stability, it is preferred that the polysiloxane (H) having the acid anhydride group or the epoxy group produced after condensation contains no by-products (for example, alcohols or water) and catalysts; therefore the polysiloxane (H) having the acid anhydride group or the epoxy group produced can be optionally purified. There is no specific limitation to the purification method, preferably, the polysiloxane (H) having the acid anhydride group or the epoxy group can be diluted with a hydrophobic solvent, and the organic layer that has been washed with water several times is then concentrated with an evaporator to remove the alcohols and water. Additionally, the catalyst can be removed by using an ion exchange resin.

Based on 100 parts by weight of the used amount of the alkali-soluble resin (A), the used amount of the polysiloxane (H) having the acid anhydride group or the epoxy group is from 5 to 40 parts by weight; preferably is from 6 to 38 parts by weight; and more preferably is from 7 to 35 parts by weight. If the polysiloxane (H) is used, the roughness can further improve.

Without affecting the efficacy of the invention, the photosensitive resin composition according to the invention can further optionally comprise an additive (I). The additive (I) includes but is not limited to a surfactant, a filler, an adhesion promoting agent, a bridging agent, an antioxidant, an anti-coagulant, or other polymers that can improve any property (such as mechanical property).

The aforementioned surfactant can be selected from the group consisting of a cationic, an anionic, a nonionic, a zwitterionic, a polysiloxane, and a fluoro surfactant, and any combination thereof. Specifically, the surfactant includes but is not limited to polyoxyethylene alkyl ethers such as polyoxyethylene lauryl ether, polyoxyethylene stearyl ether, or polyoxyethylene oleyl ether; polyoxyethylene alkyl phenyl ethers such as polyoxyethylene octyl phenyl ether or polyoxyethylene nonyl phenyl ether; polyethylene glycol diesters such as polyethylene glycol dilaurate and polyethylene glycol distearate; sorbitol anhydride fatty acid esters; fatty acid-modified polyesters; and tertiary amine-modified polyurethanes. The aforementioned surfactant can be used alone or in combination.

Specific examples of the surfactant are KP (manufactured by Shin-Etsu Chemical Co., Ltd.), SF-8427 (manufactured by Toray Dow Corning Silicone Co., Ltd.), Polyflow (manufactured by Kyoeisha Oil Chemical Co., Ltd.), F-Top (manufactured by Tochem Product Co., Ltd.), Megafac (manufactured by Dainippon Ink and Chemicals (DIC) Co., Ltd.), Fluorade (manufactured by Sumitomo 3M, Ltd.), Asahi Guard (manufactured by Asahi glass Co., Ltd.), Surflon (manufactured by Asahi glass Co., Ltd.), or SINOPOL E8008 (manufactured by Sino-Japan Chemical Co., Ltd.).

The filler includes but is not limited to glass or aluminium.

Specific examples of the adhesion promoting agent are vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane, 3-glycidoxypropylmethyldiethoxysilane, 2-(3,4-epoxycyclohexyl)ethyltrimethoxysilane, 3-chloropropylmethyldimethoxysilane, 3-chloropropyltrimethoxysilane, 3-methacryloyloxypropyl trimethoxysilane or 3-mercaptopropyltrimethoxysilane.

Specific examples of the antioxidant are 2,2-thiobis(4-methyl-6-t-butyl phenol) or 2,6-di-t-butyl phenol.

Specific example of the anti-coagulant is sodium polyacrylate.

Specific examples of the bridging agent are epoxy compounds such as 1031S or 157S-70 manufactured by Japan Epoxy Resins Co., Ltd, or resins.

Based on 100 parts by weight of the used amount of the alkali-soluble resin (A), the used amount of the filler, the adhesion promoting agent, the antioxidant, the anti-coagulant, or polymers other than the alkali-soluble resin (A) in the additive (I) is preferably below 10 parts by weight; more preferably below 6 parts by weight.

Based on 100 parts by weight of the used amount of the alkali-soluble resin (A), the used amount of the surfactant in the additive (I) is preferably below 6 parts by weight; more preferably below 4 parts by weight.

Based on 100 parts by weight of the used amount of the alkali-soluble resin (A), the used amount of the bridging agent in the additive (I) is below 100 parts by weight; more preferably below 80 parts by weight.

The photosensitive resin composition of the invention is prepared by, for instance, placing and stirring the alkali-soluble resin (A), the compound (F) represented by Formula (a), the epoxy resin (G) containing the fluorene skeleton represented by Formula (b), the compound (B) containing the ethylenically unsaturated group, the photoinitiator (C), and the black pigment (E) in an agitator such that the ingredients are evenly mixed into a solution state. When necessary, the additive (I) such as the surfactant, the filler, the adhesion promoting agent, the bridging agent, the antioxidant, and the anti-coagulant can be added. After the solution is evenly mixed, the photosensitive resin composition in a solution state can be obtained.

The preparation method of the photosensitive resin composition of the invention is not particularly limited. For instance, the black pigment (E) can be directly added and dispersed in other ingredients of the photosensitive resin composition in order to form the photosensitive resin composition. Alternately, a portion of the pigment (E) can first be dispersed in a portion of a medium including the alkali-soluble resin (A) and the solvent (D) to form a pigment dispersion solution, and then mixed with the rest of the photoinitiator (C), the solvent (D), the compound (F) represented by Formula (a), and the epoxy resin (G) containing the fluorene skeleton represented by Formula (b) to prepare the photosensitive resin composition. The dispersion steps of the black pigment (E) can be performed by mixing the ingredients with a mixer such as a beads mill or a roll mill.

The present invention also provides a black matrix, which is formed by photosensitive resin composition as mentioned above.

The black matrix according to the invention can be prepared by performing, in sequence, the treatments of pre-baking, exposure, development, and post exposure baking (PEB) to the photosensitive resin composition. The film thickness of the black matrix formed can vary depending on the application. Specifically, when applying the black matrix to an LCD, the film thickness is, for instance, in the range of 0.8 μm to 1.2 μm, but is not limited thereto. When applying the black matrix to a touch panel, the film thickness is, for instance, in the range of 1.5 μm to 2.5 μm, but is not limited thereto. In particular, when the film thickness is 1 μm, the optical density range of the black matrix is preferably above 3.0; more preferably from 3.2 to 5.5; even more preferably from 3.5 to 5.5.

More specifically, the black matrix of the invention can form a pre-baked coating film on a substrate by coating the photosensitive resin composition on the substrate through a coating method such as spin-coating or cast coating and then removing the solvent through reduced pressure drying and a pre-bake treatment. The conditions of the reduced pressure drying and pre-bake can be specified based on the type and the mix ratio of each ingredient. Generally, the reduced pressure drying can be performed at a pressure of less than 200 mmHg for 1 second to 20 seconds and the pre-bake treatment can be performed at a temperature of 70° C. to 110° C. for 1 minute to 15 minutes. After the pre-bake treatment, the coating film is exposed by a specified mask, and the unnecessary portion is removed by immersing the exposed coating film in a developing solution at a temperature of 23±2° C. for 15 seconds to 5 minutes so as to form a specific pattern. The light used in the exposure step is preferably an ultraviolet light such as a g-line, an h-line, or an i-line, and the ultra-violet irradiation device can be, for instance, a(n) (ultra-)high pressure mercury vapor lamp or a metal halide lamp.

Specific examples of the developing solution are, for instance, solutions of basic compounds such as sodium hydroxide, potassium hydroxide, sodium carbonate, sodium hydrogen carbonate, potassium carbonate, potassium hydrogen carbonate, sodium silicate, sodium methyl silicate, aqueous ammonia, ethylamine, diethylamine, dimethyl ethanolamine, tetramethylammonium hydroxide, tetraethylammonium hydroxide, choline, pyrrole, piperidine, or 1,8-diazabicyclo-[5,4,0]-7-undecene. The concentration of the developing solution is generally from 0.001 to 10 percentages by weight (wt %); preferably from 0.005 to 5 percentages by weight (wt %); more preferably 0.01 to 1 percentages by weight (wt %).

Generally, after treatment with the developing solution, the pattern is first washed with water and then air-dried with compressed air or compressed nitrogen. Next, a heating device such as a hot plate or an oven is used to perform the post-bake treatment. The temperature of the post-bake is generally in the range of 150° C. to 250° C., wherein the heating time is about 5 minutes to 60 minutes when the hot plate is used and about 15 minutes to 150 minutes when the oven is used. After the treatment steps, the black matrix can be formed on the substrate.

Specific examples of the substrate are, for instance, an alkali-free glass, a soda-lime glass, a hard glass (such as Pyrex glass), and a silica glass used in a liquid crystal display element, and such glasses with a transparent conductive film attached thereon; or a substrate such as a photoelectric conversion device substrate (such as a silicon substrate) used in, for instance, a solid imaging device.

The present invention also provides a color filter comprising the black matrix as mentioned above.

The formation method of the color filter according to the invention can be performed by coating the photosensitive composition for a color filter, which is mixed into a solution state, on a substrate by a coating method such as spin-coating, cast coating, or roll coating, wherein the black matrix for separating each pixel color layer is formed on the substrate in advance by using the photosensitive resin composition. After coating, most of the solvent is removed by a method of reduced pressure drying, and then the solvent is removed by pre-baking to form a pre-baked coating film.

The aforementioned conditions of the reduced pressure drying and pre-bake can be specified based on the type and the mix ratio of each ingredient. Generally, the reduced pressure drying can be performed at a pressure of 0 mmHg to 200 mmHg for 1 second to 60 seconds, and the pre-bake can be performed at a temperature of 70° C. to 110° C. for 1 minute to 15 minutes. After the pre-bake, the coating film is exposed by a specified mask, and the unnecessary portion is removed by immersing and developing the exposed coating film in a developing solution at a temperature of 23±2° C. for 15 seconds to 5 minutes to form a specific pattern. The light used in the exposure step is preferably an ultraviolet light such as a g-line, a h-line, or an i-line, and the ultra-violet irradiation device can be, for instance, a(n) (ultra-)high pressure mercury vapor lamp or a metal halide lamp.

After development, the pattern is first washed with water and then air-dried with compressed air or compressed nitrogen, and then a heating device such as a hot plate or an oven is used to perform the post-bake treatment. The conditions of the post-bake treatment are the same as described above and are not repeated herein.

The steps are repeated in sequence for the photosensitive composition of each color (mainly including red, green, and blue) to prepare the pixel layer of the color filter. Next, in a vacuum environment with a temperature in the range of 220° C. to 250° C., an indium tin oxide (ITO) film is formed on the pixel layer. When needed, after the ITO film is etched and wired, a polyimide for a liquid crystal alignment film is coated and burned to obtain the color filter for a liquid crystal display element.

The present invention further provides a liquid crystal display element comprising the color filter as mentioned above.

The liquid crystal display element according to the invention can be formed by the following method: the color filter substrate formed by the preparation method of the color filter and a driving substrate with a thin film transistor (TFT) are placed opposite to each other with a gap (cell gap) between the two, and then the surrounding area of the two substrates is laminated with a sealing agent. Next, a liquid crystal is injected into the gap separated by the surface of the substrates and the sealing agent to seal the injection hole and to form a liquid crystal cell. Then, a polarizer is laminated to the outer surface of the liquid crystal cell, i.e. the other side surfaces of each of the substrates forming the liquid crystal cell so as to fabricate the liquid crystal display element.

The liquid crystal can be a liquid crystal compound or a liquid crystal composition. The specific composition of the liquid crystal is not particularly limited, and any liquid crystal compound and liquid crystal composition known by those skilled in the art can be used.

Moreover, the liquid crystal alignment film is used to limit the alignment of the liquid crystal molecules and is not particularly limited, and can be any inorganic matter or organic matter. Furthermore, the technique of forming the liquid crystal alignment film is well known by those skilled in the art and is thus not repeated herein.

The following examples are given for the purpose of illustration only and are not intended to limit the scope of the present invention.

### SYNTHESIS EXAMPLE

Synthesis of alkali-soluble resin (A)

### Synthesis Example 1

### Preparation of a Resin (A-1-1) Having an Unsaturated Group

A 500 mL four-necked flask was continuously added with 100 parts by weight of a fluorene epoxy compound (Model ESF-300, manufactured by Nippon Steel Chemical Co., epoxy equivalent 231), 30 parts by weight of acrylic acid, 0.3 parts by weight of benzyltriethylammonium chloride, 0.1 parts by weight of 2,6-di-t-butyl-p-cresol, and 130 parts by weight of propylene glycol methyl ether acetate, wherein the feeding rate was controlled at 25 parts by weight/min, the temperature was maintained in the range of 100° C. to 110° C., and the mixture was reacted for 15 hours to obtain a light yellow and transparent mixture solution having a solid content concentration of 50 wt %.

Next, 100 parts by weight of the mixture solution was dissolved in 25 parts by weight of ethylene glycol ethyl ether acetate, and at the same time, 6 parts by weight of tetrahydrophthalic anhydride and 13 parts by weight of benzophenonetetracarboxylic dianhydride (BTDA) were added, and then the mixture solution was heated to 110° C. to 115° C. and reacted for 2 hours to obtain the resin (A-1-1) having an unsaturated group, wherein the resin (A-1-1) having an unsaturated group had an acid value of 98.0 mgKOH/g.

### Synthesis Example 2

### Preparation of a Resin (A-1-2) Having an Unsaturated Group

A 500 mL four-necked flask was continuously added with 100 parts by weight of a fluorene epoxy compound (Model ESF-300, manufactured by Nippon Steel Chemical Co., epoxy equivalent 231), 30 parts by weight of acrylic acid, 0.3 parts by weight of benzyltriethylammonium chloride, 0.1 parts by weight of 2,6-di-t-butyl-p-cresol, and 130 parts by weight of propylene glycol methyl ether acetate, wherein the feeding rate was controlled at 25 parts by weight/min, the temperature was maintained in the range of 100° C. to 110° C., and the mixture was reacted for 15 hours to obtain a light yellow and transparent mixture solution having a solid content concentration of 50 wt %.

Next, 100 parts by weight of the mixture solution was dissolved in 25 parts by weight of ethylene glycol ethyl ether acetate, and at the same time, 13 parts by weight of benzophenone tetracarboxylic dianhydride was added, and then the mixture solution was reacted for 2 hours at 90° C. to 95° C. Then, 6 parts by weight of tetrahydrophthalic anhydride was added, and the mixture solution was reacted for 4 hours at 90° C. to 95° C. to obtain the resin (A-1-2) having an unsaturated group, wherein the resin (A-1-2) having an unsaturated group had an acid value of 99.0 mgKOH/g.

### Synthesis Example 3

### Preparation of a Resin (A-1-3) Having an Unsaturated Group

A reaction vessel was added with 400 parts by weight of an epoxy compound (Model NC-3000, manufactured by Nippon Kayaku Co. Ltd.; epoxy equivalent 288), 102 parts by weight of acrylic acid, 0.3 parts by weight of methoxyphenol, 5 parts by weight of triphenyl phosphine, and 264 parts by weight of propylene glycol methyl ether acetate, wherein the temperature was maintained at 95° C. and the mixture was reacted for 9 hours to obtain an intermediate product having an acid value of 2.2 mgKOH/g. Then, 151 parts by weight of tetrahydrophthalic anhydride was added and the mixture was reacted for 4 hours at 95° C. to obtain the resin (A-1-3) having an acid value of 102 mgKOH/g and a weight averaged molecular weight of 3,200.

### Synthesis Example 4

### Preparation of an Other Alkali-Soluble Resin (A-2-1)

A round-bottomed flask installed with a stirrer and a condenser was added with 1 part by weight of 2,2′-azobisisobutyronitrile, 240 parts by weight of propylene glycol methyl ether acetate, 20 parts by weight of methacrylic acid, 15 parts by weight of styrene, 35 parts by weight of benzyl methacrylate, 10 parts by weight of glycerol monomethacrylate, and 20 parts by weight of N-phenylmaleimide, and the interior of the flask was filled up with nitrogen. Then, the flask was slowly stirred and the temperature was raised to 80° C. to evenly mix each reactant, and a polymerization reaction was performed for 4 hours. Then, the temperature of the reactants was raised to 100° C., and 0.5 parts by weight of 2,2′-azobisisobutyronitrile was added. After polymerization was performed for 1 hour, the alkali-soluble resins (A-2-1) could be obtained.

### Synthesis Example 5

### Preparation of an Other Alkali-Soluble Resin (A-2-2)

A round-bottomed flask installed with a stirrer and a condenser was added with 2 parts by weight of 2,2′-azobisisobutyronitrile, 300 parts by weight of propylene glycol methyl ether acetate, 15 parts by weight of methacrylic acid, 15 parts by weight of 2-hydroxy ethyl acrylate, and 70 parts by weight of benzyl methacrylate, and the interior of the flask was filled up with nitrogen. Then, the flask was slowly stirred and the temperature was raised to 80° C. to evenly mix each reactant, and a polymerization reaction was performed for 3 hours. Then, the temperature of the reactants was raised to 100° C., and 0.5 parts by weight of 2,2′-azobisisobutyronitrile was added. After polymerization was performed for 1 hour, the alkali-soluble resin (A-2-2) could be obtained.

### Synthesis of Polysiloxane (H)

### Synthesis Example 6

Adding 0.5 mole of methyltrimethoxysilane (hereinafter referred to as MTMS), 0.45 mole of phenyltrimethoxysilane (hereinafter referred to as PTMS), 0.05 mole of 3-(triethoxysilyl) propyl succinic anhydride (hereinafter referred to as GF-20) and 180 g 4-hydroxy-4-methyl-2-pentanone (hereinafter referred to DAA) into a 500 ml three-necked flask, an aqueous oxalic acid solution (0.40 g oxalic acid/75 g water) was added at room temperature stirring within 30 minutes. Next, the flask was immersed at 30° C. in oil bath and stirred for 30 minutes. Then, the temperature of the oil bath was raised to 110° C. After 6 hours, the solvent was removed using distillation to obtain the polysiloxane (H-1).

### Synthesis Examples 7 to 9

Synthesis Examples 7 to 9 were conducted in a manner identical to that of Synthesis Example 6 of the polysiloxane (H-1) with different reaction conditions as well as altered ingredients and amounts which are illustrated in Table 1.

TABLE 1

| | Composition | | | | | | | | | | | | | |
|---|---|---|---|---|---|---|---|---|---|---|---|---|---|---|
| Synthesis | silane monomer/polysiloxane (mol) | | | | | | | | Solvent (g) | | Catalyst (g) | | Temp. | Time |
| Example | MTMS | DMDMS | PTMS | PTES | GF-20 | TMSG | TMSOX | DMS-S27 | PGEE | DAA | water | Oxalic acid | (° C.) | (hour) |
| H-1 | 0.50 | | 0.45 | | 0.05 | | | | | 180 | 75 | 0.4 | 110 | 6 |
| H-2 | | 0.45 | | 0.50 | | 0.04 | | 0.01 | 100 | 100 | 75 | 0.35 | 105 | 6 |
| H-3 | 0.62 | | 0.19 | 0.16 | | | 0.03 | | 160 | | 75 | 0.5 | 120 | 6 |
| H-4 | 0.60 | | 0.40 | | | | | | | 180 | 75 | 0.4 | 110 | 6 |

MTMS methyltrimethoxysilane
DMDMS dimethyldimethoxysilane
PTMS phenyltrimethoxysilane
PTES phenyltriethoxysilane
GF-20 3-(triethoxysilyl)propyl succinic anhydride
TMSG 3-(trimethoxysilyl)propyl glutaric anhydride
TMSOX 3-ethyl-3-{[3-(trimethoxysilyl)propoxy]methyl} epoxypropane
DMS-S27 the silanol end portion of polysiloxane (manufactured by Gelest Co., Ltd.)
PGEE propylene glycol monoethyl ether
DAA 4-hydroxy-4-methyl-2-pentanone

Formation of a Black Matrix

Each of the photosensitive resin compositions prepared according to the conditions of Table 2 and 3 was placed in a coater (Model MS-A150; purchased from Hsin Kong Trade Co., Ltd.) and was coated on a glass substrate having a size of 100 mm×100 mm by a method of spin-coating, followed by reduced pressure drying at a pressure of 100 mmHg for 5 seconds. Then, the glass substrate with the photosensitive resin compositions was pre-baked at 100° C. for 2 minutes to form a pre-baked coating film. Then, the pre-baked coating film was irradiated by an ultraviolet light (exposure machine model: AG500-4N; manufactured by M&R Nano Technology) at an energy density of 100 mJ/cm², and then the pre-baked coating film was immersed in a developing solution (0.04% potassium hydroxide) at 23° C. for 2 minutes. After washing with pure water, the pre-baked coating film was post baked in an oven at 240° C. for 30 minutes. A shading film was thus formed on the glass substrate.

Assays

(1) Film Shrinkage

A film thickness (δd1) of a selected point of the aforementioned coating film after exposing was measured. The film was placed in an oven at 240° C. for 30 minutes (as the aforementioned pre-baked step), and an other film thickness (δd2) was measured at the same point. The film shrinkage ratio was calculated as the following Formula (IV):

film shrinkage ratio(%)=[(δd1−δd2)/(δd1)]×100 (IV)

∘: film shrinkage ratio≦10%

Δ: 10%<film shrinkage ratio≦15%

X: 15%<film shrinkage ratio

(2) Roughness

A non-contact white light interferometer (model: WLILAB; manufactured by BMT) was used to measure a surface of the black matrix, and the surface roughness (Ra) was measured and the unit was nm.

⊚: Ra≦40 nm

∘: 40 nm<Ra≦70 nm

Δ: 70 nm<Ra≦100 nm

X: 100 nm<Ra

TABLE 2

| | | | Example | | | | | | |
|---|---|---|---|---|---|---|---|---|---|
| Components | | | 1 | 2 | 3 | 4 | 5 | 6 | 7 |
| alkali-soluble resin (A) | A-1 | A-1-1 | 100 | | | 30 | | | 100 |
| (parts by weight) | | A-1-2 | | 100 | | | 50 | | |
| | | A-1-3 | | | 100 | | | 70 | |
| | A-2 | A-2-1 | | | | 70 | 50 | | |
| | | A-2-2 | | | | | | 30 | |

| compound containing an | B-1 | 40 | | | 120 | | | 300 |
|---|---|---|---|---|---|---|---|---|
| ethylenically unsaturated | B-2 | | 80 | 80 | | 250 | | |
| group (B) (parts by weight) | B-3 | | | 100 | | | 150 | |
| photoinitiator (C) | C-1 | 10 | | | 25 | | | 80 |
| (parts by weight) | C-2 | | 25 | | | 70 | 30 | |
| | C-3 | | | 50 | 10 | | 30 | |
| solvent (D) | D-1 | 1200 | 2000 | | 5000 | | 7000 | 4000 |
| (parts by weight) | D-2 | | 500 | 3500 | | 6500 | | 4000 |
| black pigment (E) | E-1 | 100 | | 200 | | 550 | 500 | |
| (parts by weight) | E-2 | | 350 | | 400 | | 100 | 700 |
| compound (F) represented | F-1 | 5 | | | 25 | | | 40 |
| by Formula (a) | F-2 | | 10 | | 5 | 15 | | |
| (parts by weight) | F-3 | | | 20 | | | 35 | |
| epoxy resin (G) containing | G-1 | 3 | | | 15 | 5 | | |
| a fluorene skeleton | G-2 | | 10 | | | 15 | 30 | |
| represented by Formula (b) | G-3 | | | 5 | | | | 25 |
| (parts by weight) | | | | | | | | |
| other epoxy resin (G) containing a | | | | | | | | |
| fluorene skeleton represented by | | | | | | | | |
| Formula (b) (parts by weight) | | | | | | | | |
| polysiloxane (H) | H-1 | | | | | | | 40 |
| (parts by weight) | H-2 | | 5 | | | 25 | | |
| | H-3 | | | 15 | | | | |
| | H-4 | | | | 20 | | | |
| Assays | film | ◯ | ◯ | ◯ | ◯ | ◯ | ◯ | ◯ |
| | shrinkage | | | | | | | |
| | ratio | | | | | | | |
| | surface | ◯ | ⊚ | ⊚ | ◯ | ⊚ | ◯ | ⊚ |
| | roughness | | | | | | | |

TABLE 3

| | | | Comparative example | | | | | |
|---|---|---|---|---|---|---|---|---|
| Components | | | 1 | 2 | 3 | 4 | 5 | 6 |
| alkali-soluble resin (A) | A-1 | A-1-1 | | 100 | 100 | 100 | | 100 |
| (parts by weight) | | A-1-2 | | | | | | |
| | | A-1-3 | | | | | | |
| | A-2 | A-2-1 | 100 | | | | | |
| | | A-2-2 | | | | | 100 | |

| compound containing an | B-1 | 150 | | | | 150 | 150 |
|---|---|---|---|---|---|---|---|
| ethylenically unsaturated | B-2 | | 150 | | | | |
| group (B) (parts by weight) | B-3 | | | 150 | 150 | | |
| photoinitiator (C) | C-1 | 40 | 40 | 40 | 40 | | |
| (parts by weight) | C-2 | | | | | 40 | |
| | C-3 | | | | | | 40 |
| solvent (D) | D-1 | 3000 | 3000 | 3000 | 3000 | 3000 | 3000 |
| (parts by weight) | D-2 | | | | | | |
| black pigment (E) | E-1 | 400 | | | | | 400 |
| (parts by weight) | E-2 | | 400 | 400 | 400 | 400 | |
| compound (F) represented | F-1 | 20 | | | | | |
| by Formula (a) | F-2 | | | 20 | 20 | | |
| (parts by weight) | F-3 | | | | | 25 | |
| epoxy resin (G) containing | G-1 | 15 | | | | | |
| a fluorene skeleton | G-2 | | 20 | | | | |
| represented by Formula (b) | G-3 | | | | | | |
| (parts by weight) | | | | | | | |
| other epoxy resin (G) containing a | | | | | 20 | | |
| fluorene skeleton represented by | | | | | | | |
| Formula (b) | | | | | | | |
| (parts by weight) | | | | | | | |
| polysiloxane (H) | H-1 | | | | | | |
| (parts by weight) | H-2 | | | | | | |
| | H-3 | | | | | | |
| | H-4 | | | | | | |
| Assays | film shrinkage | X | X | ◯ | ◯ | X | X |
| | ratio | | | | | | |
| | surface | ◯ | ◯ | X | X | X | X |
| | roughness | | | | | | |

### In Table 2 and 3:

B-1 trimethylolpropyl triacrylate
B-2 dipentaerythritol tetraacrylate
B-3 dipentaerythritol hexaacrylate
C-1 1-[9-ethyl-6-(2-methylbenzoyl)-9H-carbazol-3-yl]-ethanone 1-(O-acetyloxime) (product names OXE-02; manufactured by Ciba Specialty Chemicals)
C-2 1-[4-(phenylthio)phenyl]-octane-1,2-dione 2-(O-benzoyloxime) (product names OXE-01; manufactured by Ciba Specialty Chemicals)
C-3 2-methyl-1-(4-methylthio phenyl)-2-morpholino-1-propanone (product names IRGACURE 907; manufactured by Ciba Specialty Chemicals)
D-1 propylene glycol methyl ether acetate
D-2 cyclohexanone
E-1 product names MA100 (manufactured by Mitsubishi Chemical Co.)
E-2 product names MA230 (manufactured by Mitsubishi Chemical Co.)
F-1 a compound represented by Formula (a-1)
F-2 a compound represented by Formula (a-4)
F-3 a compound represented by Formula (a-7)
G-1 9,9-bis[4-(2-glycidyloxyethoxy)phenyl]fluorene
G-2 9,9-bis[4-(2-glycidyloxyethoxy)-3,5-dimethylphenyl]fluorene
G-3 9,9-bis[4-(2-glycidyloxyethoxy)-3-phenylphenyl]fluorene
G′ 9,9-bis(4-glycidyloxyphenyl) fluorene

While embodiments of the present invention have been illustrated and described, various modifications and improvements can be made by persons skilled in the art. It is intended that the present invention is not limited to the particular forms as illustrated, and that all modifications not departing from the spirit and scope of the present invention are within the scope as defined in the following claims.

What is claimed is:

1. A photosensitive resin composition comprising:
an alkali-soluble resin (A);
a compound (B) containing an ethylenically unsaturated group;
a photoinitiator (C);
a solvent (D);
a black pigment (E);
a compound (F) represented by Formula (a); and
an epoxy resin (G) containing a fluorene skeleton represented by Formula (b);
wherein
the alkali-soluble resin (A) comprises a resin having an unsaturated group (A-1) obtained by polymerizing a mixture which comprises an epoxy compound (i) having at least two epoxy groups and a compound (ii) having at least one carboxylic acid group and at least one ethylenically unsaturated group; 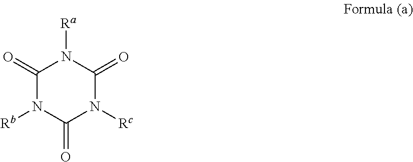
in Formula (a):
R^{a}, R^{b} and R^{c} each independently represent a trialkoxysilyl group linked to an alkylene group or an arylene group; and 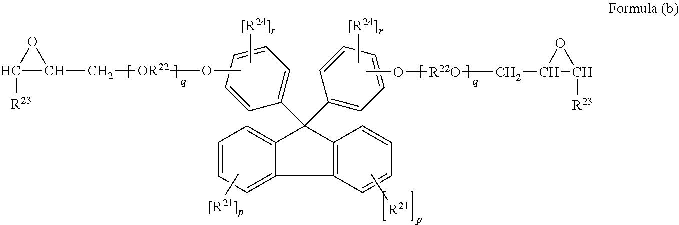
in Formula (b):
R²¹ represents a cyano group, a C₁-C₅ alkyl group or a halogen atom;
R²² represents a C₁-C₁₃ alkylene group;
R²³ represents a hydrogen atom or a methyl group;
R²⁴ represents a C₁-C₅ alkyl group, a C₆-C₁₂ aryl group or a C₆-C₁₂ aralkyl group;
p represents an integer from 0 to 4;
q represents an integer from 1 to 10; and
r represents an integer from 0 to 4.

2. The photosensitive resin composition according to claim 1, wherein the epoxy compound (i) having at least two epoxy groups contains a structure represented by Formula (I): 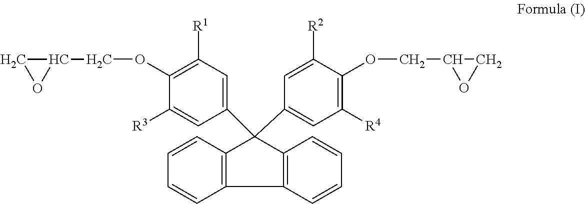
wherein:
R¹, R², R³ and R⁴ each independently represent a hydrogen atom, a halogen atom, a C₁-C₅ alkyl group, a C₁-C₅ alkoxy group, a C₆-C₁₂ aryl group or a C₆-C₁₂ aralkyl group.

3. The photosensitive resin composition according to claim 1, wherein the epoxy compound (i) having at least two epoxy groups contains a structure represented by Formula (II): 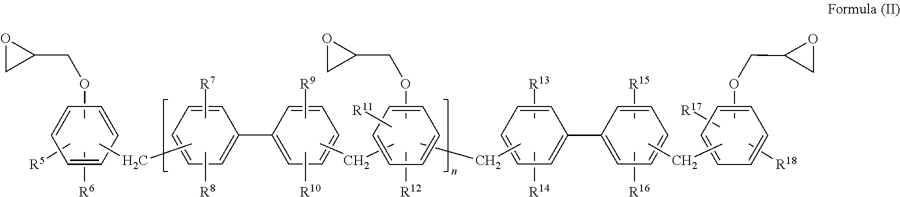
wherein:
R⁵ to R¹⁸ each independently represent a hydrogen atom, a halogen atom, a C₁-C₈ alkyl group, or a C₆-C₁₅ aromatic group; and
n represents an integer from 0 to 10.

4. The photosensitive resin composition according to claim 1, wherein based on 100 parts by weight of the used amount of the alkali-soluble resin (A), the used amount of the resin having the unsaturated group (A-1) is from 30 to 100 parts by weight; the used amount of the compound (B) containing the ethylenically unsaturated group is from 40 to 300 parts by weight; the used amount of the photoinitiator (C) is from 10 to 80 parts by weight; the used amount of the solvent (D) is from 1200 to 8000 parts by weight; the used amount of the black pigment (E) is from 100 to 700 parts by weight; the used amount of the compound (F) represented by Formula (a) is from 5 to 40 parts by weight; and the used amount of the epoxy resin (G) containing the fluorene skeleton represented by Formula (b) is from 3 to 30 parts by weight.

5. The photosensitive resin composition according to claim 1, which further comprises a polysiloxane (H) having an acid anhydride group or an epoxy group, and a monomer used in polymerization of the polysiloxane (H) includes at least one silane monomer having a structure of Formula (III):
Si(R²⁵)ₜ(OR²⁶)₄₋ₜ Formula (III),
t represents an integer from 1 to 3; when t represents 2 or 3, a plurality of R²⁵ are independently the same or different; and when 4-t represents 2 or 3, a plurality of R²⁶ are independently the same or different;
at least one of R²⁵ represents a C₁-C₁₀ alkyl group substituted by an acid anhydride group, a C₁-C₁₀ alkyl group substituted by an epoxy group or an alkoxy group substituted by an epoxy group; and the remaining R²⁵ represent a hydrogen atom, a C₁-C₁₀ alkyl group, a C₂-C₁₀ alkenyl group or a C₆-C₁₅ aromatic group; and
R²⁶ represents a hydrogen atom, a C₁-C₆ alkyl group, a C₁-C₆ acyl group or a C₆-C₁₅ aromatic group.

6. The photosensitive resin composition according to claim 5, wherein based on 100 parts by weight of the used amount of the alkali-soluble resin (A), the used amount of the polysiloxane (H) is from 5 to 40 parts by weight.

7. A black matrix formed by the photosensitive resin composition according to claim 1.

8. A color filter comprising the black matrix according to claim 7.

9. A liquid crystal display element comprising the color filter according to claim 8.
